(19) United States
(12) Patent Application Publication
(10) Pub. No.: US 2026/0100298 A1
(43) Pub. Date: Apr. 9, 2026

(54) GROMMET SYSTEM AND METHOD

(71) Applicant: Preformed Line Products Company, Cleveland, OH (US)

(72) Inventors: Nicholas Lees, Lakewood, OH (US); Benjamin Ciesielczyk, Madison, OH (US); Andrew Hanneman, Cleveland, OH (US); Douglas Bell, Cleveland, OH (US)

(21) Appl. No.: 19/351,449

(22) Filed: Oct. 7, 2025

Related U.S. Application Data
(60) Provisional application No. 63/704,284, filed on Oct. 7, 2024.

(51) Int. Cl. H01B 17/58; H02G 15/013

(52) U.S. Cl. CPC H01B 17/583; H02G 15/013

(57) ABSTRACT

A grommet includes a core that defines an aperture in a longitudinal direction, where the aperture is a straight through hole and the core is formed from a material having a first durometer. The grommet also includes a support fixed with the core, wherein the support is spaced from the aperture in a lateral direction or a normal direction orthogonal the longitudinal direction, and is formed from a material having a second durometer that is higher than the first durometer.

### CROSS-REFERENCE TO RELATED APPLICATIONS

This application claims the benefit of U.S. Provisional Application No. 63/704,284 filed Oct. 7, 2024, which is incorporated herein by reference in their entireties.

### BACKGROUND

Grommets are commonly used in a wide range of industries to provide sealing, protection, and support for cables, wires, and other elongated members passing through walls, panels, or other structures. In this regard, grommets are intended to shield the cable or wire from external damage and to provide a sealed interface that prevents the ingress of dust, moisture, or other contaminants where the cable passes through the panel, wall, or other structure.

Conventional grommets typically fall into two broad categories. The first category includes grommets that are made of highly elastic materials. Insofar as these grommets conform well to the cable or wire that they surround, providing a tight seal due to their elasticity, they often deform excessively when installed into an opening, leading to inconsistent sealing performance and a tendency to lose structural integrity over time. Furthermore, the highly deformable nature of these grommets can make installation challenging, as they may not maintain an intended shape during installation.

The second category of grommets includes those made from relatively rigid materials as compared to those of the first category. Insofar as these grommets maintain their shape relatively better during installation and provide a more consistent exterior interface, they often do not conform well to the shape of the cable or wire they are intended to seal. This lack of conformity can result in poor sealing, leaving gaps through which contaminants may pass. Additionally, the rigidity of these grommets may cause excessive stress on the cable or wire, leading to premature wear or damage.

### SUMMARY

According to one aspect, a grommet includes a core that defines an aperture in a longitudinal direction, where the core is formed from a material having a first durometer. The grommet also includes a support fixed with the core. The support is spaced from the aperture in a lateral direction orthogonal the longitudinal direction, and is formed from a material having a second durometer that is higher than the first durometer.

According to another aspect, a grommet includes a core that defines an aperture in a longitudinal direction, where the aperture is a straight through hole and the core is formed from a material having a first durometer. The grommet also includes a support fixed with the core, wherein the support is spaced from the aperture in a lateral direction or a normal direction orthogonal the longitudinal direction, and is formed from a material having a second durometer that is higher than the first durometer.

According to another aspect, a grommet includes a core that defines an aperture in a longitudinal direction, where the aperture is a straight through hole extended through a first end surface of the core and a second end surface of the core opposite the first end surface in the longitudinal direction. The grommet also includes a support fixed with the core, where the support surrounds the core and extends from the core in a lateral direction orthogonal to the longitudinal direction, the support is spaced from the aperture across the core in the lateral direction, and the first end surface or the second end surface are inclined outward in the longitudinal direction from the aperture toward the support.

According to another aspect, a grommet includes a core that defines an aperture in a longitudinal direction, where the aperture is a straight through hole extended through a first core end surface and a second core end surface opposite the first core end surface in the longitudinal direction. The grommet also includes a support integrally formed with the core, where the support is cylindrical and concentric with the core and extended around the core in a circumferential direction orthogonal to the longitudinal direction. The first core end surface and the second core end surface are inclined inward in the longitudinal direction from the aperture toward the support in a radial direction orthogonal to the longitudinal direction.

The innovation described herein describes a grommet that offers flexibility in cable routing with ease of installation and removal for a variety of gauge sizes. In addition to other described features, functions and benefits, the grommet described herein may enable secure and efficient cable management.

### BRIEF DESCRIPTION OF THE DRAWINGS

FIG. 1 is a top perspective view of an example grommet in accordance with aspects of the innovation.

FIG. 2 is a bottom perspective view of the grommet of FIG. 1.

FIG. 3 is a top perspective view of an example grommet in accordance with aspects of the innovation.

FIG. 4 is a bottom perspective view of the grommet of FIG. 3.

FIG. 5 is a top perspective view of an example grommet in accordance with aspects of the innovation.

FIG. 6 is a perspective view of a frame included in the grommet of FIG. 5.

FIG. 7 is a top perspective view of an example grommet in accordance with aspects of the innovation.

FIG. 8 is a partial perspective view of a frame included in the grommet of FIG. 7.

FIG. 9 is a top perspective view of the grommet of FIG. 7, including the frame.

FIG. 10 is a front view of the grommet of FIG. 7.

FIG. 11 is a perspective view of an example grommet in accordance with aspects of the innovation.

FIG. 12 is a front view of the grommet of FIG. 11.

FIG. 13 is a top perspective view of an example grommet in accordance with aspects of the innovation, including a core and a frame partially assembled FIG. 14 is a perspective view of the frame of FIG. 13.

FIG. 15 is a perspective view of an example grommet in accordance with aspects of the innovation.

FIG. 16 is a cross-sectional side view of the grommet of FIG. 15.

FIG. 17 is a perspective view of an example grommet in accordance with aspects of the innovation, where a top frame portion and a bottom frame portion are in contact with each other, in an open condition.

FIG. 18 is a perspective view of the grommet of FIG. 17 where the top frame portion and the bottom frame portion are space from each other, in the open condition.

FIG. 19 is a perspective view of the top frame portion of FIG. 17.

FIG. 20 is a perspective view of the bottom frame portion of FIG. 17.

FIG. 21 is a partial top perspective view of an example closure in accordance with aspects of the innovation, incorporating the grommet of FIG. 17, partially assembled.

FIG. 22 is a partial front perspective view of the closure of FIG. 21 incorporating the grommet of FIG. 17, partially assembled.

FIG. 23 is a partial, enlarged front perspective view of the closure of FIG. 21 incorporating the grommet of FIG. 17, partially assembled.

FIG. 24 is a front view of the closure of FIG. 21 incorporating the grommet of FIG. 17.

FIG. 25 is an enlarged, partial top view of the closure of FIG. 21 incorporating an example grommet in accordance with aspects of the innovation, partially assembled.

FIG. 26 is an enlarged, partial front perspective view of the closure of FIG. 21 incorporating the grommet of FIG. 25.

FIG. 27 is a perspective side view of the grommet of FIG. 25.

FIG. 28 is a front cross-sectional view of an example grommet in accordance with aspects of the innovation.

FIG. 29 is a top perspective view of an example grommet in accordance with aspects of the innovation.

FIG. 30 is a top perspective view of an example grommet in accordance with aspects of the innovation.

FIG. 31 is a top perspective view of an example grommet in accordance with aspects of the innovation.

FIG. 32 is a front cross-sectional view of the grommet of FIG. 31.

FIG. 33 is a top perspective view of an example grommet in accordance with aspects of the innovation.

FIG. 34 is a top view of the grommet of FIG. 33.

FIG. 35 side perspective view of the grommet of FIG. 33.

FIG. 36 is a bottom perspective view of an example grommet in accordance with aspects of the innovation.

FIG. 37 is a top perspective view of the grommet of FIG. 36.

FIG. 38 is a top perspective view of an example grommet in accordance with aspects of the innovation.

FIG. 39 is a bottom top perspective view of the grommet of FIG. 38.

FIG. 40 is a front cross-sectional view of the grommet of FIG. 38.

FIG. 41 is a top perspective view of an example grommet in accordance with aspects of the innovation.

FIG. 42 is a bottom perspective view of the grommet of FIG. 41.

FIG. 43 is a side perspective view of an example grommet in accordance with aspects of the innovation.

FIG. 44 is a bottom perspective view of the grommet of FIG. 43.

FIG. 45 is a bottom perspective view of an example grommet in accordance with aspects of the innovation.

FIG. 46 is a top perspective view of the grommet of FIG. 45.

### DETAILED DESCRIPTION

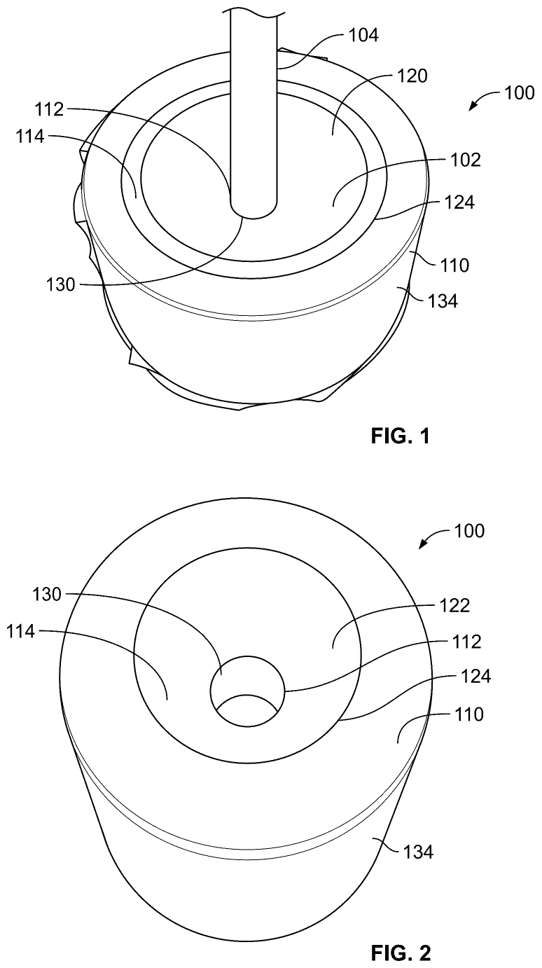

It should, of course, be understood that the description and drawings herein are merely illustrative and that various modifications and changes can be made in the structures disclosed without departing from spirit and scope of the present disclosure. Referring now to the drawings, wherein like numerals refer to like parts throughout the several views, in accordance with an aspect of the innovation, FIG. 1 depicts a grommet 100 including a core 102 configured to directly contact and seal against a cable 104 that passes through the grommet 100 in a longitudinal direction. The grommet 100 also includes a support 110 that maintains a shape of the grommet 100 when the core 102 receives the cable 104, compressing the core 102 as compared to when the grommet 100 is in an uncompressed free state.

In this regard, the core 102 is formed from a material having a first durometer, and the support 110 is formed from a material having a second durometer that is higher than the first durometer. With this construction, the core 102 is formed from a relatively soft, deformable material as compared to the support 110, and the support 110 is formed from a relatively rigid, unyielding material as compared to the core 102. As such, when the core 102 receives the cable 104, the core 102 deforms more than the support 110 with respect to a proportion of an original shape of the core 102 and the support 110 held in the free state. In this manner, the support 110 compresses the core 102 against the cable 104 when the core 102 is in the free state and then receives the cable 104, sealing the core 102 against the cable 104.

The core 102 defines an aperture 112 that receives the cable 104. More specifically, a core body 114 that forms the core 102 defines the aperture 112 in the longitudinal direction, where the cable 104 passes through the grommet 100. The core body 114 and the aperture 112 are cylindrical and concentric with each other. As such, the core 102 deforms uniformly from the aperture 112, around the cable 104, in a radial direction of the core body 114 that is a lateral direction or a normal direction orthogonal to the longitudinal direction when the core 102 receives the cable 104.

The core body 114 extends in the longitudinal direction, and forms a top face 120. As shown in FIG. 2, the core body 114 also forms a bottom face 122 offset from the top face 120 in the longitudinal direction, such that the top face 120 and the bottom face 122 are formed at opposite sides of the core 102 in the longitudinal direction.

As shown between FIGS. 1 and 2, the top face 120 and the bottom face 122 mirror each other across a central plane of the core body 114 in the longitudinal direction. The central plane is an imaginary plane oriented in the radial direction, orthogonal to the longitudinal direction, and bisects the core body 114 through a midsection of the core body 114. As such, the core body 114 is shaped such that the core body 114 compresses symmetrically along the aperture 112 in the longitudinal direction, across the central plane.

The top face 120 and the bottom face 122 are each inclined inward, toward each other in the longitudinal direction across the central plane, along the radial direction from an outer core surface 124 toward an inner core surface 130. In this manner, the top face 120 and the bottom face 122 each form a counter sink concentric with the aperture 112 in the longitudinal direction. With this construction, a width of the core body 114 necks down from the outer core surface 124 to a reduced width at the aperture 112. As such, a contact area between the cable 104 and the core 102 at the inner core surface 130 is reduced, increasing a pressure and corresponding sealing strength between the core 102 and the cable 104 at the contact area with a same compressive force generated when the core 102 is deformed between the cable 104 and the support 110.

The core 102 and the support 110 are each formed from a silicone rubber, where the support 110 is overmolded upon the outer core surface 124. While, in the depicted embodiment, the core 102 and the support 110 are each formed from silicone rubber, the core 102 and the support 110 may each additionally or alternatively include gel, natural rubber, neoprene, ethylene propylene diene monomer (EPDM), nitrile rubber, thermoplastic elastomer, or Viton in constructions featuring different durometers. Also, while the depicted support 110 is overmolded upon the core 102, the core 102 and the support 110 may additionally or alternatively be adhered, chemically bonded, fitted with each other, molded together in a same injection process, or otherwise mated through a curing process to remain fixed to each other with respect to the cable 104 without departing from the without departing from the scope of the subject disclosure.

In the depicted embodiment, the core 102 has a durometer rating of 10 on the shore 00 scale, and the support 110 has a durometer rating of 30 on the shore A scale. The first durometer corresponding to the core 102, and the second durometer corresponding to the support 110 may each take a variety of values where the second durometer is higher than the first durometer without departing from the scope of the subject disclosure.

In the depicted embodiment, the core body 114 is shaped to receive and form an effective seal against a variety of cables having diameters in a range of 0.4 inches to 1.0 inches. Notably, a variety of combinations of shapes and sizes may be employed to affect an effective seal range between the core 102 and the cable 104 without departing from the scope of the subject disclosure.

Notably, compressing the core 102 between the cable 104 and the support 110 in the radial direction raises the top face 120 and the bottom face 122 in the longitudinal direction. In an embodiment, the top face 120 and the bottom face 122 are each inclined inward such that the top face 120 and the bottom face 122 are raised no more than to a point of being parallel with each other and flat in the radial direction when the core 102 receives the cable 104.

In this manner, the core body 114 avoids increasing an overall width of the grommet 100 in the longitudinal direction by extending beyond the support 110. As such, the core body 114 is configured to maintain a shape of the grommet 100 in the longitudinal direction when the core 102 receives the cable 104.

The outer core surface 124 and the inner core surface 130 define opposite sides of the core 102 in the radial direction, where the inner core surface 130 defines the aperture 112, and the outer core surface 124 is mated with the support 110 at an inner support surface 132. The support 110 also includes an outer support surface 134 that defines an opposite side of the support 110 in the radial direction.

The core body 114 is a single piece of material. More specifically, the core body 114 is a single piece of silicone rubber which extends continuously from the top face 120 to the bottom face 122.

While, as depicted, the cable 104 is a fiber optic cable that carries light signals to transport information, the grommet 100 may be configured to receive a variety of objects. In this regard, the cable 104 may additionally or alternatively include a variety of cables, wires, pipes, tubes, rods, rails, beams, fibers, conduits, rebar, extrusions, and similarly elongated objects that pass through the aperture 112 in the longitudinal direction without departing from the scope of the subject disclosure.

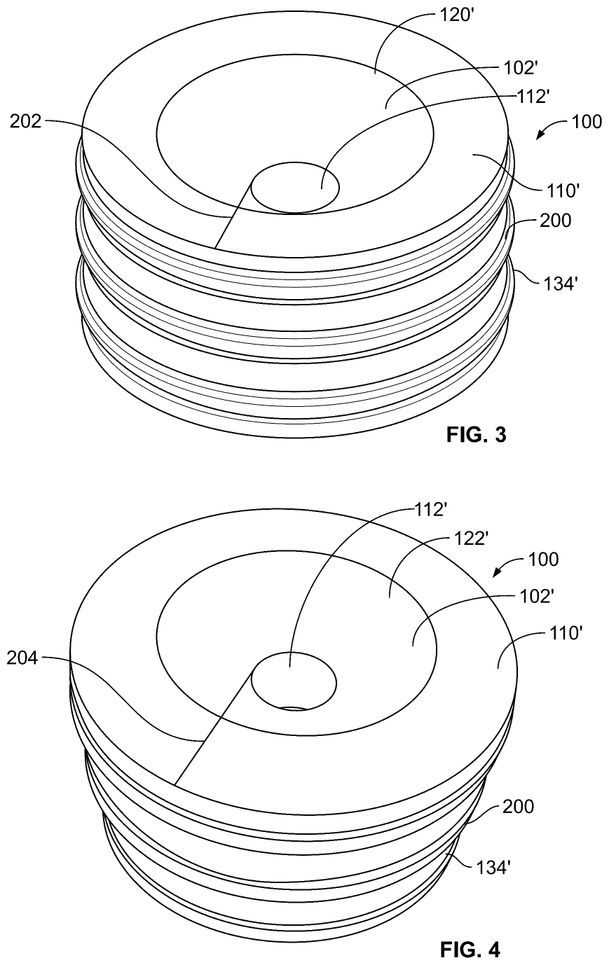

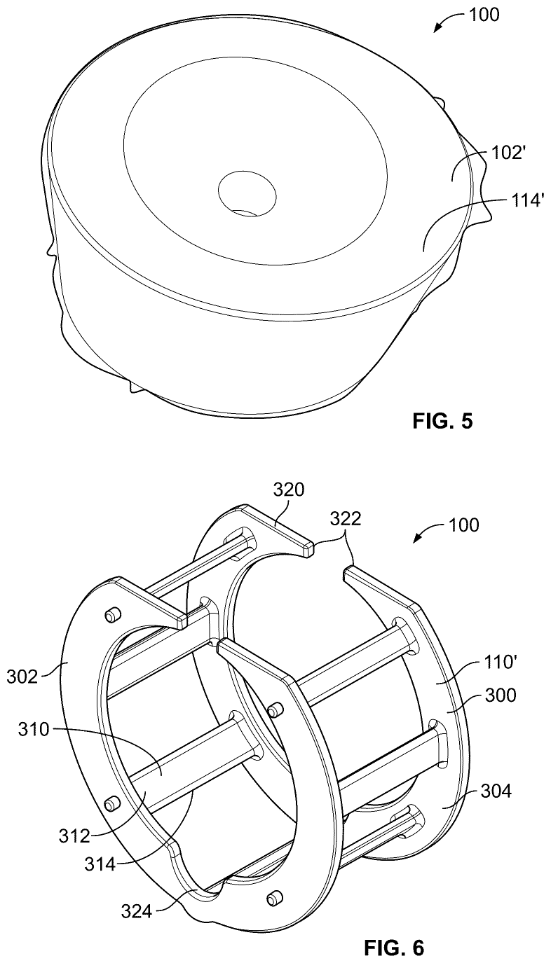

FIGS. 3 and 4 illustrate an alternate embodiment of the grommet 100 of FIGS. 1 and 2. In the embodiment of FIGS. 3 and 4, like elements with the grommet 100 of FIGS. 1 and 2 are denoted with the same reference numerals but followed by a primed suffix (′). FIGS. 3 and 4 illustrate an embodiment of the grommet 100 where the outer support surface 134′ includes a plurality of ribs 200 that extend outward from the support 110′ and away from the core 102′ in the radial direction, and around the support 110′ in a circumferential direction orthogonal to the radial direction. The plurality of ribs 200 are grip features that provide added traction and increase a grip strength by a user handling the grommet 100. The plurality of ribs 200 may additionally or alternatively provide added traction as grip features to a housing that supports the grommet 100, such as a closure for a plurality of cables including the cable 104.

In the depicted embodiment, the core 102′ and the support 110′ are each formed from a silicone rubber, such that the grommet 100 is entirely formed from silicone rubber from the outer support surface 134′ to the aperture 112′. With this construction, the core 102′ and the support 110′ may be cut by a user handling the grommet 100 to form an opening that extends from the outer support surface 134′ to the inner core surface 130′.

To this end, the top face 120′ and the bottom face 122′ respectively include a top indicator 202 and a bottom indicator 204. The top indicator 202 and the bottom indicator 204 are each respectively formed from an incongruity along the top face 120′ and the bottom face 122′ to indicate to a user a cut that may be made into the grommet 100 for receiving the cable 104. With this construction, the grommet 100 receives the cable 104 in the aperture 112′ where a cut end of the cable 104 is inserted through the aperture 112′, or where the cable 104 is laid into the aperture 112 through a cut following the top indicator 202 or the bottom indicator 204.

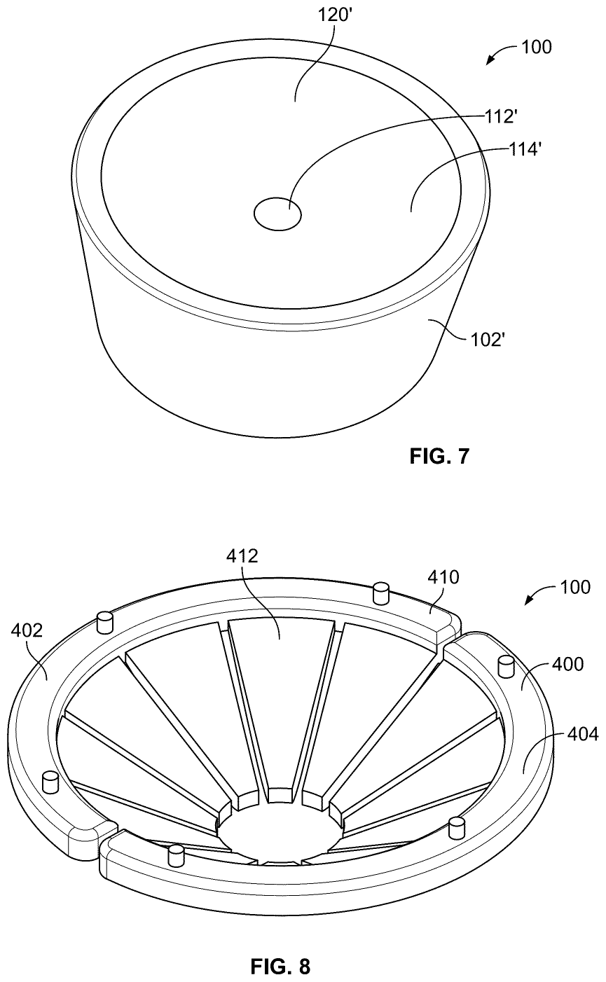

FIGS. 5 and 6 illustrate an alternate embodiment of the grommet 100 of FIG. 1-4. In the embodiment of FIGS. 5 and 6, like elements with the grommet 100 of FIG. 1-4 are denoted with the same reference numerals but followed by a primed suffix (′). FIGS. 5 and 6 illustrate an embodiment of the grommet 100 where the support 110′ is a frame 300 that provides internal reinforcement to the core 102′.

In this regard, the core body 114′ is overmolded upon the frame 300, and completely encases the frame 300. As shown in FIG. 6, the frame 300 includes a first ring 302 spaced from a second ring 304, and connected across a plurality of cross beams 310 in the longitudinal direction. The cross beams 310 are interposed between an separate the first ring 302 and the second ring 304 in the longitudinal direction.

The cross beams 310 are each elongated in the circumferential direction. As such, each of the cross beams 310 includes a broad face 312 directed toward the aperture 112′ in the radial direction, and an edge 314 that extends in the circumferential direction. With this construction, the cross beams 310 may receive an increased amount of force from the core body 114′ when the core 102′ receives the cable 104 and compresses between the cable 104 and the support 110′, without tearing or cutting the core 102′.

The frame 300 is configured to flex with the core 102′ when the core receives the cable 104. In this regard, the cross beams 310 may flex in the radial direction with respect to the aperture 112′ when the core 102′ receives the cable 104. Notably, the reduced width of the edge 314 of each cross beam 310 as compared to the corresponding broad face 312 enables the cross beam 310 to flex in the radial direction in response to relatively less force as compared to a thicker construction.

The frame 300 includes a cutoff portion 320 that defines a gap 322 in each of the first ring 302 and the second ring 304. The frame 300 also includes a thinned portion 324 formed in each of the first ring 302 and the second ring 304. The gap 322 and the thinned portion 324 formed in each of the first ring 302 and the second ring 304 are aligned in the longitudinal direction, and cause the frame 300 to flex in the radial direction when the core 102′ receives the cable 104. In this regard, the first ring 302 and the second ring 304 bend outward at the thinned portion 324 such that the gap 322 increases in length along the circumferential direction.

While, as depicted, the frame 300 is formed from joined metal segments, the frame 300 may additionally or alternatively be formed from a plastic or other relatively rigid material as compared to the core 102′ in a joined or continuous structure without departing from the scope of the subject disclosure.

FIG. 7-10 illustrate an alternate embodiment of the grommet 100 of FIG. 1-6. In the embodiment of FIG. 7-10, like elements with the grommet 100 of FIG. 1-6 are denoted with the same reference numerals but followed by a primed suffix (′). FIG. 7-10 illustrate an embodiment of the grommet 100 where the support 110′ is a frame 400 that provides internal reinforcement to the core 102′. Unless otherwise provided herein, the frame 400 includes similar features and functions in a similar manner as the frame 300.

In this regard, the core body 114′ is overmolded upon the frame 400, and completely encases the frame 400. As shown in FIG. 8, the frame 400 is formed from a first ring segment 402 and a second ring segment 404 aligned with each other to form a circular ring 410. The circular ring is concentric with the aperture 112′ in the longitudinal direction.

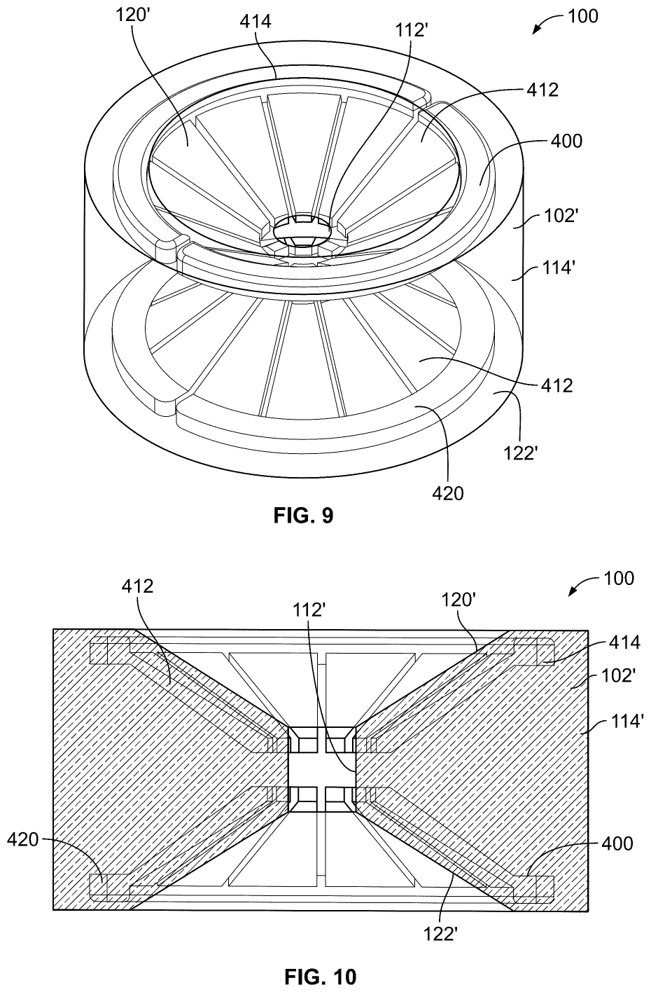

The frame 400 includes a plurality of fins 412 that extend inward in the radial direction, toward the aperture 112′ from the first ring segment 402 and the second ring segment 404. The fins 412 are each inclined from the ring 410 in the longitudinal direction, in a manner that matches the top face 120′ and the bottom face 122′ of the core 102′. With this construction, as shown in FIGS. 9 and 10, the fins 412 are embedded in the core 102′ and extend along the counter sink surfaces formed in the top face 120′ and the bottom face 122′.

Referring back to FIG. 8, the fins 412 are regularly spaced from each other along the ring 410 in the circumferential direction, and maintain the spacing uniformly in the radial direction toward the aperture 112′. The fins 412 each have a flat profile that extends along the ring 410 in the circumferential direction, and toward the aperture 112′ in the radial direction. With this construction, the fins 412 cover a relatively large area in the longitudinal direction, and flex with the top face 120′ and the bottom face 122′ when the core 102′ receives the cable 104. The fins 412 are integrally formed with the ring 410, and bend at the ring 410 when the core 102′ receives the cable 104. Because the frame 400 is relatively rigid as compared to the core 102′, the frame 400, including the fins 412, inhibits excessive deformation of the core 102′ with respect to an overall shape of the grommet 100, and guides the cable 104 through the grommet 100 when the core 102′ receives the cable 104.

As shown in FIGS. 9 and 10, the frame 400 includes a first ring 414 and a second ring 420 which embody the ring 410 design described with respect to FIG. 8. In this regard, with reference to FIGS. 9 and 10, the first ring 414 is disposed in the core 102′ with the fins 412 disposed along the top face 120′, and the second ring 420 is disposed in the core 102′ with the fins 412 disposed along the bottom face 122′.

The first ring 414 and the second ring 420 are each encased in the core 102′, and suspended from each other in the core 102′. More specifically, the first ring 414 and the second ring 420 are coaxial with each other and the aperture 112′, and mirror each other across the grommet 100 in the longitudinal direction.

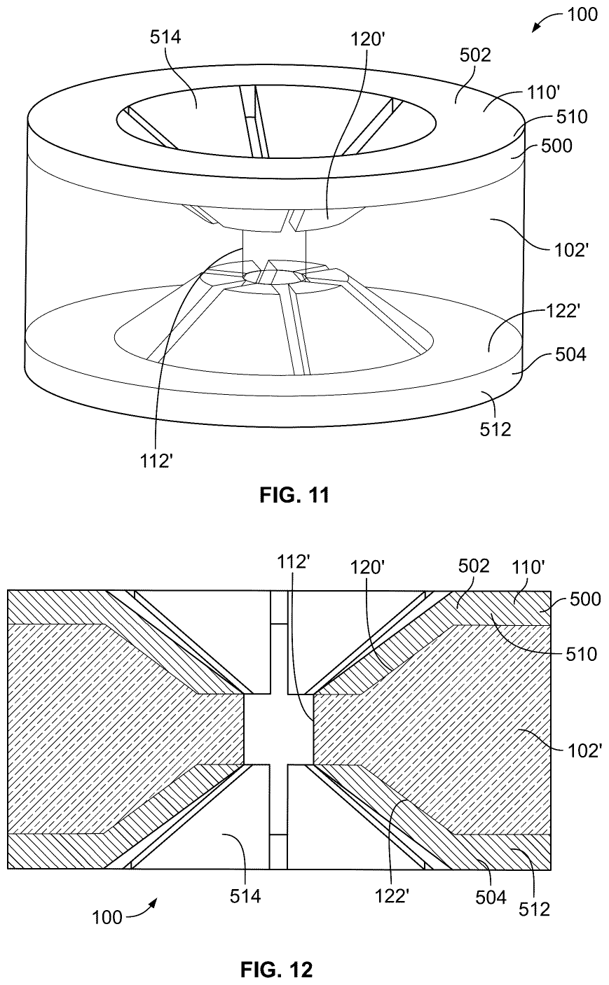

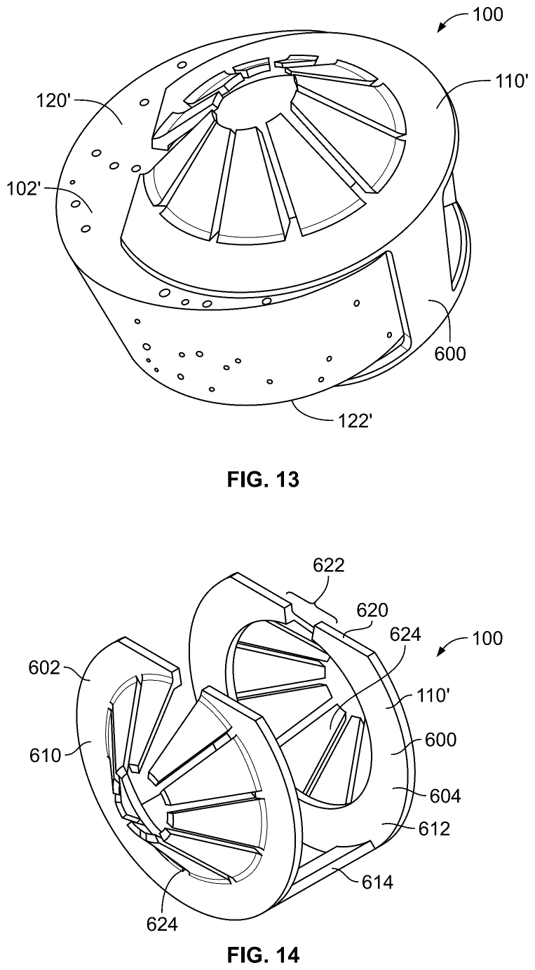

FIGS. 11 and 12 illustrate an alternate embodiment of the grommet 100 of FIG. 1-10. In the embodiment of FIGS. 11 and 12, like elements with the grommet 100 of FIG. 1-10 are denoted with the same reference numerals but followed by a primed suffix (′). FIGS. 11 and 12 illustrate an embodiment of the grommet 100 where the support 110′ is a frame 500 that reinforces the core 102′ as an outer chassis.

In this regard, the frame 500 includes an upper chassis 502 and a lower chassis 504 respectively disposed along the top face 120′ and the bottom face 122′ of the core 102′. The upper chassis 502 and the lower chassis 504 are laminated to the core 102′ in a manner that prevents sliding along the core 102′. In an alternative embodiment, the upper chassis 502 and the lower chassis 504 are fixed to the core 102′ such that portions thereof slide along the top face 120′ and the bottom face 122′ when the core 102′ receives the cable 104, compressing the core 102′ between the cable 104 and the frame 500.

The upper chassis 502 and the lower chassis 504 respectively include a first ring 510 and a second ring 512 that are coaxial with each other and the aperture 112′, and mirror each other across the grommet 100 in the longitudinal direction. The frame 500 also includes a plurality of fins 514 that extend inward in the radial direction, toward the aperture 112′ from the first ring 510 and the second ring 512. The fins 514 are each respectively inclined inward from the first ring 510 and the second ring 512 in the longitudinal direction, along the radial direction, in a manner that corresponds to the top face 120′ and the bottom face 122′ of the core 102′. With this construction, the fins 514 extend along the counter sink surfaces formed in the top face 120′ and the bottom face 122′.

The fins 514 are regularly spaced from each other along the first ring 510 and the second ring 512 in the circumferential direction, and maintain the spacing uniformly in the radial direction toward the aperture 112′. The fins 514 each have a flat profile that respectively extends along the first ring 510 and the second ring 512 in the circumferential direction, and toward the aperture 112′ in the radial direction. With this construction, the fins 514 cover a relatively large area of the top face 120′ and the bottom face 122′, and flex with the top face 120′ and the bottom face 122′ when the core 102′ receives the cable 104. The fins 514 are respectively integrally formed with the first ring 510 and the second ring 512, and bend at the first ring 510 and the second ring 512 when the core 102′ receives the cable 104. Because the frame 500 is relatively rigid as compared to the core 102′, the frame 500, including the fins 514, inhibits excessive deformation of the core 102′ with respect to an overall shape of the grommet 100, and guides the cable 104 through the grommet 100 when the core 102′ receives the cable 104.

FIGS. 13 and 14 illustrate an alternate embodiment of the grommet 100 of FIG. 1-12. In the embodiment of FIGS. 13 and 14, like elements with the grommet 100 of FIG. 1-12 are denoted with the same reference numerals but followed by a primed suffix (′). FIGS. 13 and 14 illustrate an embodiment of the grommet 100 where the support 110′ is a frame 600 that provides reinforcement to the core 102′ as an outer chassis. Unless otherwise provided herein, the frame 600 includes similar features and functions in a similar manner as the frame 500.

The frame 600 includes an upper chassis 602 and a lower chassis 604 respectively disposed along the top face 120′ and the bottom face 122′ of the core 102′. The upper chassis 602 and the lower chassis 604 are laminated to the core 102′ in a manner that prevents sliding along the core 102′. In an alternative embodiment, the upper chassis 602 and the lower chassis 604 are fixed to the core 102′ such that portions thereof slide along the top face 120′ and the bottom face 122′ when the core 102′ receives the cable 104, compressing the core 102′ between the cable 104 and the frame 600. In a further embodiment, the upper chassis 602 and the lower chassis 604 are fixed to the core 102′ by friction or deformation in an interference fit with the core 102′, upon placement onto the core 102′ by a user.

The upper chassis 602 and the lower chassis 604 respectively include a first ring 610 and a second ring 612 that are coaxial with each other and the aperture 112′, and mirror each other across the grommet 100 in the longitudinal direction. The first ring 610 and the second ring 612 are connected to each other across a cross beam 614 that extends in the longitudinal direction. The cross beam 614 holds the first ring 610 and the second ring 612 a predetermined distance from each other in the longitudinal direction, and allows the first ring 610 and the second ring 612 to flex away from each other in the longitudinal direction when placed onto the core 102′ by a user. Further, the cross beam 614 retains the first ring 610 and the second ring 612 in contact with the top face 120′ and the bottom face 122′ upon placement onto the core 102′. Because the frame 600 is relatively rigid as compared to the core 102′, the frame 600, including the first ring 610 and the second ring 612, inhibits excessive deformation of the core 102′ with respect to an overall shape of the grommet 100, and guides the cable 104 through the grommet 100 when the core 102′ receives the cable 104.

The frame 600 also includes a cutoff portion 620 in the first ring 610 and the second ring 612. The cutoff portion 620 defines a gap 622 in each of the first ring 610 and the second ring 612. The cutoff portion 620 provides the gap 622 formed in each of the first ring 610 and the second ring 612 aligned in the longitudinal direction, and enables the frame 600 to flex in the radial direction without tearing, breaking, or plastically deforming when the core 102′ receives the cable 104. In this regard, the first ring 610 and the second ring 612 bend outward from a location opposite from the gap 622 in the radial direction, such that the gap 622 increases in length along the circumferential direction.

The frame 600 also includes a plurality of fins 624 that extend inward in the radial direction, toward the aperture 112′ from the first ring 610 and the second ring 612. The fins 624 are each respectively inclined outward from the first ring 610 and the second ring 612 in the longitudinal direction, along the radial direction, away from the top face 120′ and the bottom face 122′ of the core 102′. With this construction, the fins 624 are spaced from the top face 120′ and the bottom face 122′, guide the cable 104 in the longitudinal direction when the core 102′ receives the cable 104, and maintain a length of the cable 104 passing through the grommet 100 extended in the longitudinal direction.

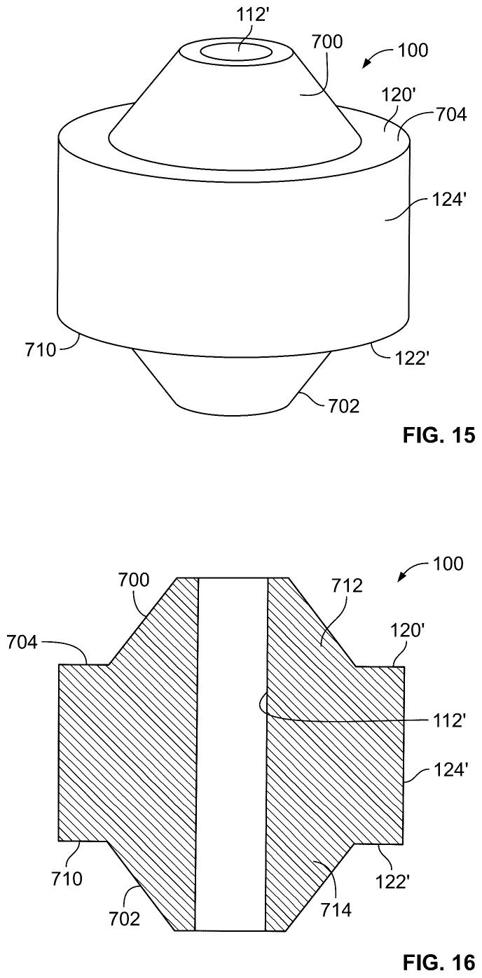

FIGS. 15 and 16 illustrate an alternate embodiment of the grommet 100 of FIG. 1-14. In the embodiment of FIGS. 15 and 16, like elements with the grommet 100 of FIG. 1-14 are denoted with the same reference numerals but followed by a primed suffix (′). FIGS. 15 and 16 illustrate an embodiment of the grommet 100 where the core 102′ extends beyond the support 110′ in the longitudinal direction.

In this regard, the core 102′ defines the aperture 112′ in the longitudinal direction as a straight through hole extended through a first end surface 700 of the core 102′ and a second end surface 702 of the core 102′ opposite the first end surface 700 in the longitudinal direction. The support 110′ fixed with the core 102′, where the support 110′ surrounds the core 102′ and extends from the core 102′ in a lateral direction orthogonal to the longitudinal direction, the support 110′ is spaced from the aperture 112′ across the core 102′ in the lateral direction, and the first end surface 700 or the second end surface 702 are inclined outward in the longitudinal direction from the aperture 112′ toward the support 110′.

More specifically, the core 102′ and the support 110′ are cylindrical and concentric with the aperture 112′. The first end surface 700 and the second end surface 702 are inclined outward in the longitudinal direction, at the aperture 112′, forming frusto-conical shapes extended outward from the support 110′ in the longitudinal direction. The support 110′ forms a first ledge 704 that extends straight from the frusto-conical shape at the first end surface 700 of the core 102′ in the lateral direction and the longitudinal direction, and the support 110′ forms a second ledge 710 that extends straight from the frusto-conical shape at the second end surface 702 in the lateral direction and the longitudinal direction.

As such, the core 102′ forms a first protrusion 712 at the first end surface 700, and a second protrusion 714 at the second end surface 702. The first protrusion 712 and the second protrusion 714 respectively extend away from the top face 120′ and the bottom face 122′ in the longitudinal direction. The first protrusion 712 and the second protrusion 714 each form a truncated cone shape with a base respectively disposed on the top face 120′ and the bottom face 122′ where the first protrusion 712 and the second protrusion 714 are concentric with the aperture 112′. With this construction, the first protrusion 712 and the second protrusion 714 each narrow along the longitudinal direction, respectively in directions away from the top face 120′ and the bottom face 122′.

The first protrusion 712 and the second protrusion 714 are integrally formed with the core 102′ at the top face 120′ and the bottom face 122′, and thinner than the core 102′ at the outer core surface 124′ in the radial direction. As such, the first protrusion 712 and the second protrusion 714 are relatively flexible as compared to the core 102′ at the outer core surface 124′, guide the cable 104 in the longitudinal direction when the core 102′ receives the cable 104, and maintain a length of the cable 104 passing through the grommet 100 extended in the longitudinal direction. Also, because the core 102′ is thicker at the outer core surface 124′ as compared to the first protrusion 712 and the second protrusion 714, the core 102′ is less inclined to deform at the outer core surface 124′ as compared to the first protrusion 712 and the second protrusion 714, retaining an overall shape of the grommet 100 when the core 102′ receives the cable 104.

In the depicted embodiment, the support 110′ has a constant thickness around an entire circumference of the core 102′ in a radial direction orthogonal to the longitudinal direction. The support 110′ extends continuously along the core 102′ in the longitudinal direction, and terminates at the first end surface 700 and the second end surface 702 of the core 102′, where the support forms the first ledge 704 and the second ledge 710. The core 102′ and the support 110′ are integrally formed from a same material including a rubber or an elastomer.

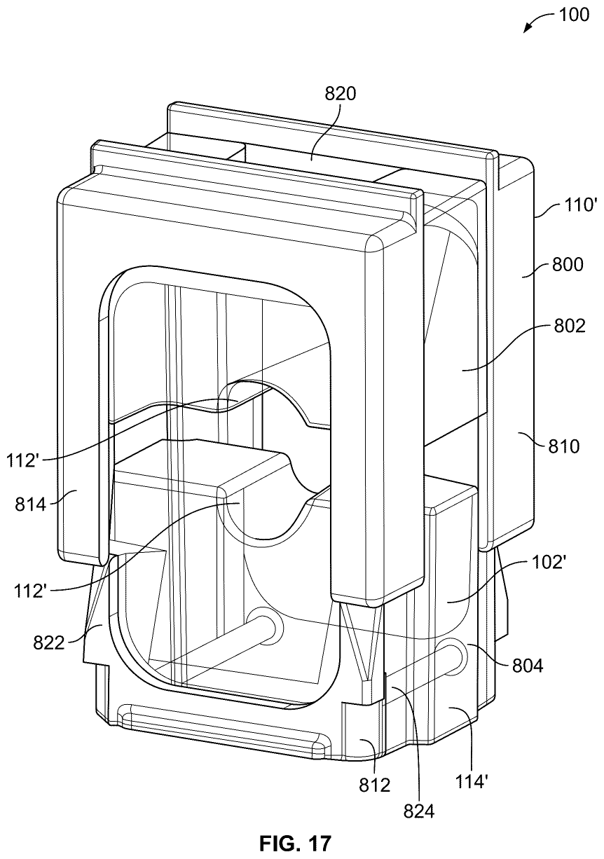

FIG. 17-20 illustrate an alternate embodiment of the grommet 100 of FIG. 1-16. In the embodiment of FIG. 17-20, like elements with the grommet 100 of FIG. 1-16 are denoted with the same reference numerals but followed by a primed suffix (′). FIG. 17-20 illustrate an embodiment of the grommet 100 where the support 110′ is a frame 800 that retains the core 102′. In this regard, the core 102′ is fitted within the frame 800, and the frame 800 supports the core 102′ as an outer chassis.

The frame 800 is formed from a rigid material as compared to the core 102′, and shaped to resist deformation with respect to an overall shape of the grommet 100 when the core 102′ receives the cable 104. In this regard, in the depicted embodiment, the core 102′ is formed from polyurethane, and elements of the frame 800 are formed from a plastic or a metal that is relatively rigid as compared to the polyurethane forming the core 102′. Notably, because the frame 800 is relatively rigid as compared to the core 102′, the core body 114′ is relatively restricted from flexing and becoming spaced from the cable 104 under high pressure when the core 102′ is closed around the cable 104.

The core 102′ is formed from a top core portion 802 and a bottom core portion 804. The frame 800 includes a top frame portion 810 and a bottom frame portion 812 that respectively retain the top core portion 802 and the bottom core portion 804 in the frame 800. More specifically, the top frame portion 810 includes a first plurality of legs 814 extended in a lateral direction, orthogonal to the longitudinal direction, with a cornered profile that receives and mates with edges of the top core portion 802. The top frame portion 810 also includes a top frame end portion 820 that connects the first plurality of legs 814, extends along the top core portion 802 between the first plurality of legs 814, and directly contacts an exterior surface the top core portion 802. With this construction, the top core portion 802 is obstructed from moving in the longitudinal direction, and is obstructed from moving upward or sideways in the radial direction, orthogonal to the longitudinal direction relative to the top frame portion 810.

The bottom frame portion 812 includes a second plurality of legs 822 extended in a direction parallel to the first plurality of legs 814. The bottom frame portion 812 also includes a bottom frame end portion 824 that connects the second plurality of legs 822, extends along the bottom core portion 804 between the second plurality of legs 822, and extends through the bottom core portion 804. With this construction, the bottom core portion 804 is obstructed from moving in the longitudinal direction, and is obstructed from moving downward or sideways in the radial direction, orthogonal to the longitudinal direction relative to the bottom frame portion 812.

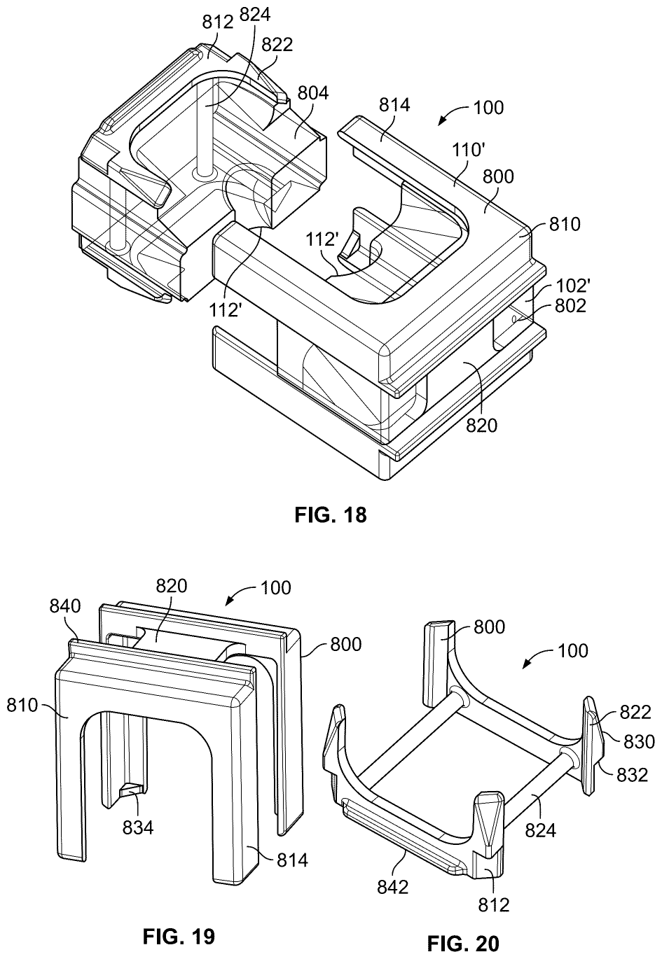

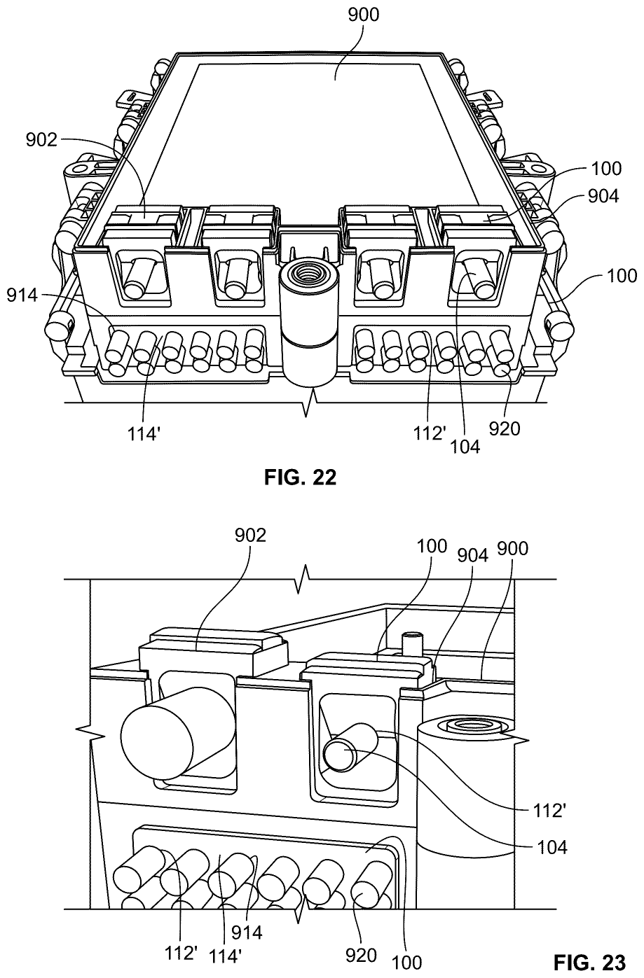

The frame 800 is configured to engage the top core portion 802 and the bottom core portion 804 in a sliding relationship from an open condition to a closed condition (see FIG. 22). In the open condition, the top core portion 802 and the bottom core portion 804 are separated from each other, and respectively held in the top frame portion 810 and the bottom frame portion 812. In this regard, as shown in FIG. 18, the top frame portion 810 and the bottom frame portion 812 may be positioned separate from each other. With this construction, the cable 104 may be laid or dropped into the top core portion 802 or the bottom core portion 804 where the top core portion 802 or the bottom core portion 804 define the aperture 112′. The cable 104 may alternatively by inserted into the aperture 112′ when the core 102′ and the frame 800 are in the open condition or the closed condition.

Also, as shown in FIG. 17, the top frame portion 810 and the bottom frame portion 812 may be engaged with each other through the first plurality of legs 814 and the second plurality of legs 822. The first plurality of legs 814 and the second plurality of legs 822 are engaged in a sliding relationship, and may slide from the open condition, orthogonal to the longitudinal direction, toward the closed condition.

As shown in FIG. 20, the second plurality of legs 822 each respectively forms a ramp 830 and step 832 on an outer surface that engages a complementary inner surface of the first plurality of legs. In this regard, as shown in FIG. 19, the first plurality of legs 814 each respectively include a rib 834 that extends across an inner surface of the corner profile. As shown between FIGS. 19 and 20, the rib 834 in each of the first plurality of legs 814 and the ramp 830 and the step 832 formed in each of the second plurality of legs 822 form a catch mechanism that locks the top frame portion 810 and the bottom frame portion 812 in the closed position.

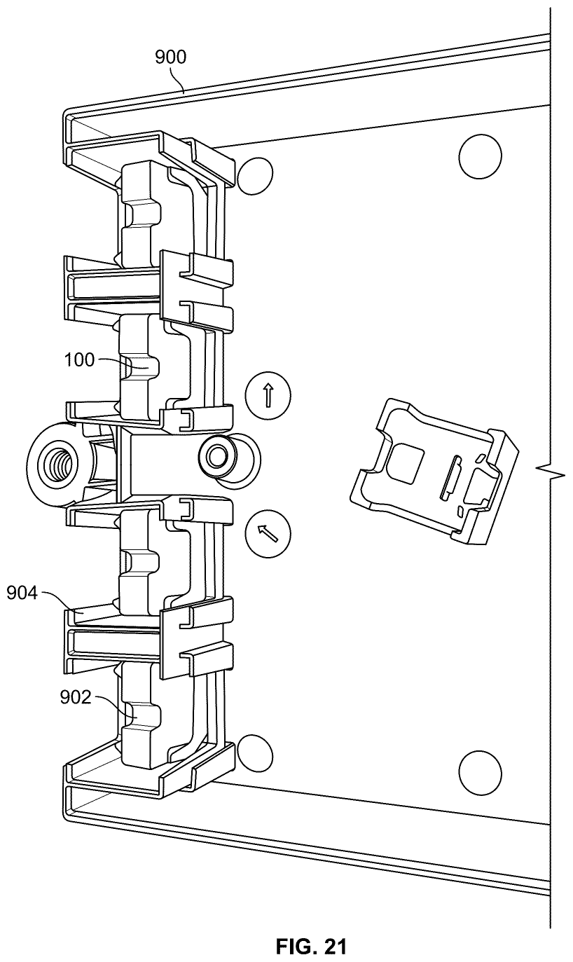

The top frame portion 810 and the bottom frame portion 812 each respectively include a first set of protuberances 840 and a second set of protuberances 842 that are gripping features which may be handled by a user, or fixed in a closure, such as the closure depicted in FIG. 21.

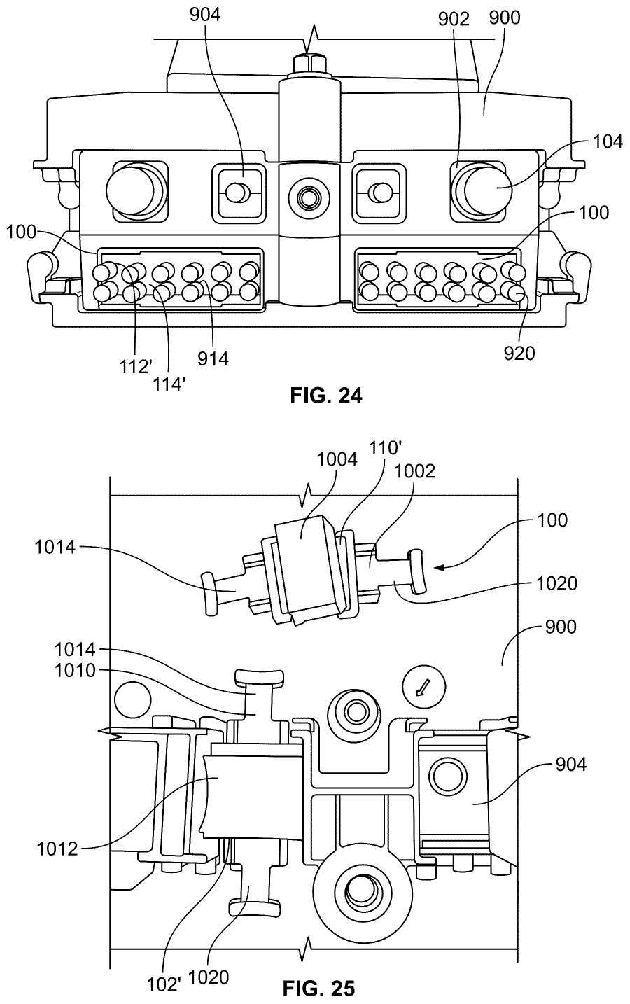

In this regard, FIG. 21 depicts an example closure 900 for fiber optic cables, where interior cable elements may be isolated from exterior elements without protection from an exterior jacket. FIG. 21-24 depict the grommet 100 disposed in the closure 900, among a plurality of grommets 902 that include similar features and function in a similar manner as the grommet 100.

With reference to FIG. 21, the closure 900 includes a plurality of caps 904 that respectively, and individually retain the plurality of grommets 902. In the depicted embodiment, the plurality of grommets 902 are pressure fit into the closure 900, however the grommets 902 may be fixed in the caps 904 in a variety of manners without departing from the scope of the subject disclosure. With this construction, each cable 104 may be individually maneuvered with respect to the closure 900, without moving any other cable 104.

FIG. 22-24 depict an alternate embodiment of the grommet 100 of FIG. 1-21. In the embodiment of FIG. 22-24, like elements with the grommet 100 of FIG. 1-21 are denoted with the same reference numerals but followed by a primed suffix (′). FIG. 22-24 illustrate an embodiment of the grommet 100 where the core body 114′ defines a plurality of apertures 914, including the aperture 112′, that respectively hold a plurality of cables 920 respectively similar to the cable 104.

FIG. 25-27 illustrate an alternate embodiment of the grommet 100 of FIG. 1-24. In the embodiment of FIG. 25-27, like elements with the grommet 100 of FIG. 1-24 are denoted with the same reference numerals but followed by a primed suffix (′). FIG. 25-27 illustrate an embodiment of the grommet 100 where the support 110′ is a frame 1000 that retains the core 102′ and directly engages the cable 104.

With reference to FIG. 25, frame 1000 includes a top frame portion 1002 fixed with a top core portion 1004, and includes a bottom frame portion 1010 fixed with a bottom core portion 1012. While, in the depicted embodiment, the core 102′ is overmolded upon the top frame portion 1002 and the bottom frame portion 1010, the core 102′ may be fixed with the frame in a variety of ways without departing from the scope of the present disclosure.

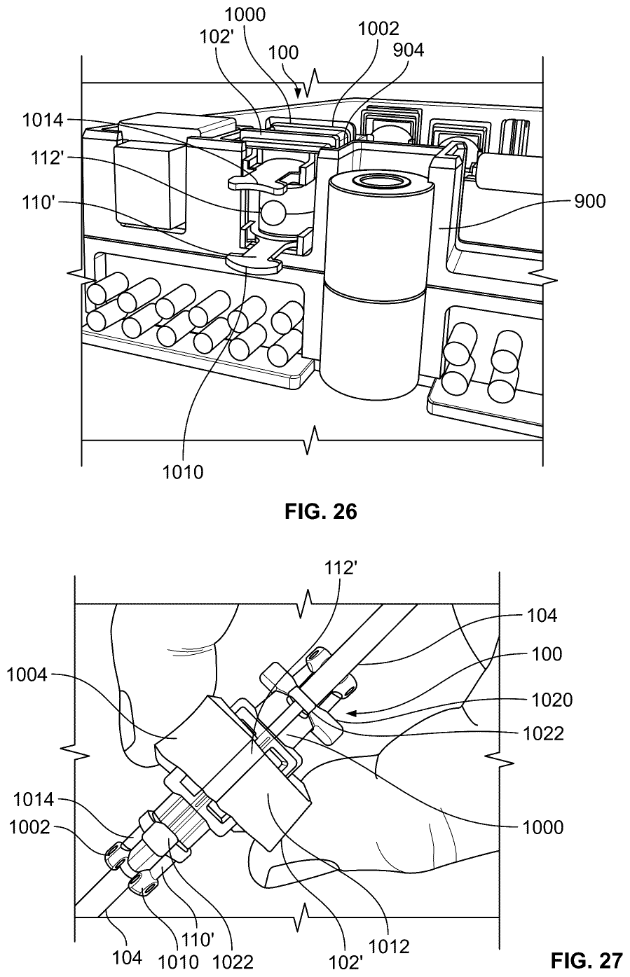

Each of the top frame portion 1002 and the bottom frame portion 1010 include a first frame portion 1014 and a second frame portion 1020 that, as shown in FIGS. 26 and 27, extend in opposite directions from the core 102′ in the longitudinal direction. With continued reference to FIGS. 26 and 27, the first frame portion 1014 and the second frame portion 1020 in each of the top frame portion 1002 and the bottom frame portion 1010 are aligned with each other in the longitudinal direction. The corresponding first frame portions 1014 and second frame portions 1020 may be relatively spaced from each other when the core 102′ is in the open condition as shown in FIG. 25, or also when the core 102′ is uncompressed in the closed condition as shown in FIG. 26, as compared to a closed condition where the frame 1000 is fastened to the cable 104.

In this regard, as shown in FIG. 27, when the core 102′ is in the closed condition, where the top core portion 1004 and the bottom core portion 1012 contact each other in a direction orthogonal to the longitudinal direction and define the aperture 112′, the first frame portions 1014 and the second frame portions 1020 may be fastened to each other across the cable 104 with ties 1022. In this manner, the core 102′ is compressed around the cable 104 in the closed condition, sealing the cable 104 across the core 102′ in the longitudinal direction.

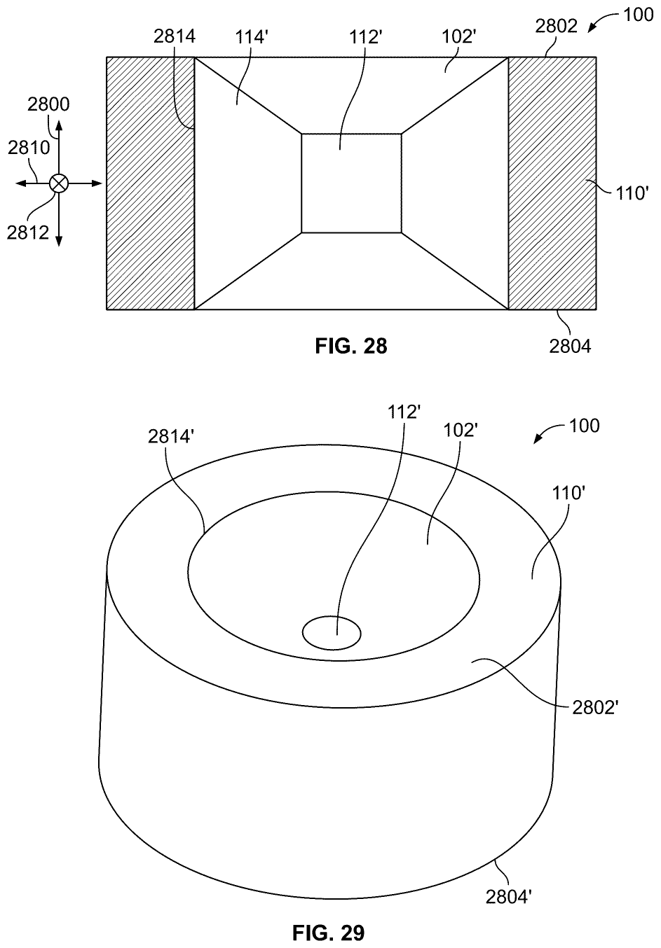

FIG. 28 illustrates an alternate embodiment of the grommet 100 of FIG. 1-27. In the embodiment of FIG. 28, like elements with the grommet 100 of FIG. 1-27 are denoted with the same reference numerals but followed by a primed suffix (′). FIG. 28 illustrates an embodiment of the grommet 100 including the core 102′ molded with the support 110′.

In this regard, the grommet 100 includes the core 102′ which defines the aperture 112′ in the longitudinal direction, indicated by arrow 2800. The aperture 112′ is a straight through hole and the core 102′ is molded and formed from a material having the first durometer. The aperture 112′ extends continuously through the core 102′ in the longitudinal direction such that the cable 104′ may be inserted directly through the grommet 100 with minimal obstruction. More specifically, the aperture 112′ extends through a first end surface 2802 of the core and a second end surface 2804 of the core opposite the first end surface 2802 in the longitudinal direction.

With continued reference to FIG. 28, the grommet 100 also includes the support 110′ fixed with the core 102′, where the support 110′ is spaced from the aperture 112′ in a radial direction orthogonal to the longitudinal direction. The radial direction extends outward from the aperture 112′ in a lateral direction indicated by an arrow 2810 and a normal direction indicated by an arrow 2812. The lateral direction and the normal direction are orthogonal to each other and the longitudinal direction of the grommet 100.

The support 110′ is formed from a material having a second durometer that is higher than the first durometer, such that the support 110′ is relatively rigid and resistant to deformation as compared to the core 102′. With this construction, the core 102′ may elastically conform to a range of cable diameters at the aperture 112′, while the support 110′ preserves a consistent exterior geometry of the grommet 100 that reliably facilitates installation and retention within a closure.

In embodiments, the core 102′ and the support 110′ are each a unitary body formed from a material including a rubber or an elastomer. In the depicted embodiment, the core 102′ and the support 110′ are molded together, the core 102′ being formed from a first elastomer having the first durometer, and the support 110′ being formed from a second elastomer having the second durometer. The first durometer of the core 102′ corresponds to a relatively soft and deformable material, enabling the aperture 112′ to conform to and seal against an outer surface of the cable 104′. As such, the support 110′ directly confines deformation of the core 102′ around the aperture 112′ and concentrates compressive sealing forces radially inward against the cable 104′.

The support 110′ is disposed on an exterior radial surface 2814 of the core 102′ or within the core body 114′, arranged around opposite sides of the aperture 112′ in the lateral direction or the normal direction. In this manner, the support 110′ operates as a reinforcing sleeve that restricts uncontrolled expansion of the core 102′ at the exterior radial surface 2814, while the core body 114′ maintains flexibility at the aperture 112′. The integrated molding of the core 102′ and the support 110′ results in a composite structure that combines increased elasticity which enhances a seal against the cable 104 when the cable 104 is inserted through the grommet 100, and rigidity that increases structural stability and installation reliability while avoiding delamination or separation between the core 102′ and the support 110′ under repeated loading cycles.

The core 102′ and the support 110′ are cylindrical, concentric with the aperture 112′, and rounded about the longitudinal direction. The support 110′ extends with a uniform thickness in the radial direction, continuously around the core 102′ in a circumferential direction perpendicular to the radial direction. In this manner, the support 110′ surrounds the core 102′ and extends from the exterior radial surface 2814 of the core 102′ in the lateral direction and the normal direction. The concentric arrangement of the core 102′ with the support 110′ provides uniform distribution of stress when the core 102′ is compressed around the cable 104′, and ensures a consistent sealing interface along a full circumference of the aperture 112′. The rounded geometry of the core 102′ and the support 110′ also promotes ease of installation into a corresponding closure opening, reducing insertion forces while maintaining retention strength once installed.

FIG. 29 illustrates an alternate embodiment of the grommet 100 of FIG. 1-28. In the embodiment of FIG. 29, like elements with the grommet 100 of FIG. 1-28 are denoted with the same reference numerals but followed by a primed suffix (′). FIG. 29 illustrates an embodiment of the grommet 100 including the core 102′ integrally formed with the support 110′.

As shown in FIG. 29, the core 102′ defines the aperture 112′ in the longitudinal direction as a straight through hole that extends between the first end surface 2802′ and the second end surface 2804′. With continued reference to FIG. 29, the support 110′ is integrally formed with the core 102′, from a same material as the core 102′. With this construction, the grommet 100 is a single unitary body with a single durometer at the support 110′ and the core 102′.

The support 110′ is cylindrical and concentric with the core 102′ and extends around the core 102′ in the circumferential direction. The support 110′ terminates at the first end surface 2802′ and the second end surface 2804′ in the longitudinal direction, and forms a planar surface extended in the radial direction at the first end surface 2802′ and the second end surface 2804′.

The support 110′ and the core 102′ are symmetric and centered with each other in the longitudinal direction. With this construction, the grommet 100 is reversible in the longitudinal direction, and uniform in the circumferential direction, which improves ease of installation by allowing reversibility of the grommet 100 in a closure without regard to a distinct top-bottom or front-back orientation, reducing installation error rates.

The first end surface 2802′ and the second end surface 2804′ are inclined inward in the longitudinal direction from the aperture 112′ toward the support 110′ in a radial direction orthogonal to the longitudinal direction. With this arrangement, the inclined end surfaces define an inverted frusto-conical transition between the aperture 112′ and the support 110′, providing a tapered interface along both longitudinal ends of the grommet 100. As such, when the core 102′ compresses against the cable 104′ and expands in the longitudinal direction at the aperture 112′, the support 110′ may remain extended beyond the first end surface 2802′ and the second end surface 2804′ in the longitudinal direction, shielding the relatively soft core 102′ from external damage. The inclined geometry of the first end surface 2802′ and the second end surface 2804′ also directs compressive forces at the aperture 112′ toward the support 110′, channeling compressive loading into the support 110′ rather than allowing stress to spread outward into a corresponding closure.

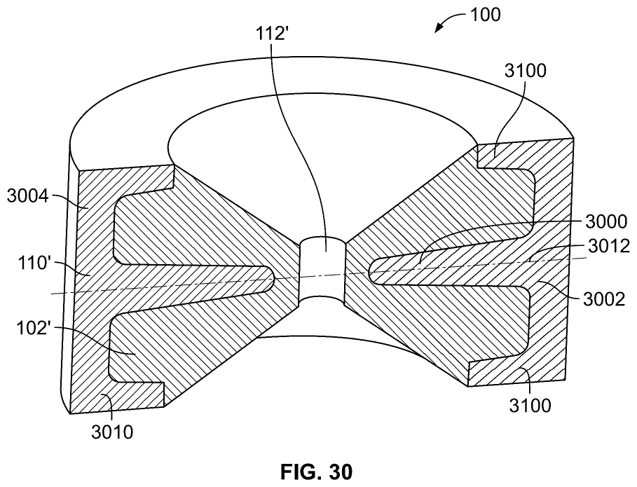

FIG. 30 illustrates an alternate embodiment of the grommet 100 of FIG. 1-29. In the embodiment of FIG. 30, like elements with the grommet 100 of FIG. 1-29 are denoted with the same reference numerals but followed by a primed suffix (′). FIG. 30 illustrates an embodiment of the grommet 100 including the support 110′ having a fin 3000 that extends radially inward from the exterior radial surface 2814′.

In this regard, the support 110′ includes a wall 3002 that encloses the exterior surface of the core 102′ in both the lateral direction and the normal direction. More specifically, the support 110′ continuously surrounds and encases the core 102′ along the circumferential direction. The wall 3002 is concentric with the aperture 112′ and extends around a full circumference of the core 102′ in the lateral direction and the normal direction.

The wall 3002 includes a first wall end portion 3004 and a second wall end portion 3010 extended opposite the first wall end portion 3004 in the longitudinal direction. The first wall end portion 3004 and the second wall end portion 3010 are symmetric with each other in the longitudinal direction, forming mirrored opposite ends of the support 110′. With this construction, the wall 3002 spans an entire length of the core 102′ in the longitudinal direction, around the entire circumference of the core 102′ in the circumferential direction.

The support 110′ further includes the fin 3000 extended inward from the wall 3002 into the core 102′ and toward the aperture 112′ in the radial direction. The fin 3000 extends from a position on the wall 3002 closer to a middle point 3012 of the wall in the longitudinal direction as compared to the first wall end portion 3004 and the second wall end portion 3010. In embodiments, the fin 3000 may be substantially rigid or elastically deformable depending on material selection and thickness, reflecting a degree of intended or elastic deflection of the fin 3000 under compressive loading in the core 102′, between the wall 3002 and the cable 104′.

When the core 102′ compresses in the radial direction, the fin 3000 may elastically deflect or deform with a predetermined resistance that opposes further expansion of the aperture 112′. In this manner, the geometry and durometer of the support 110′ directly influence and tune the overall deformation resistance of the core 102′ at the aperture 112′.

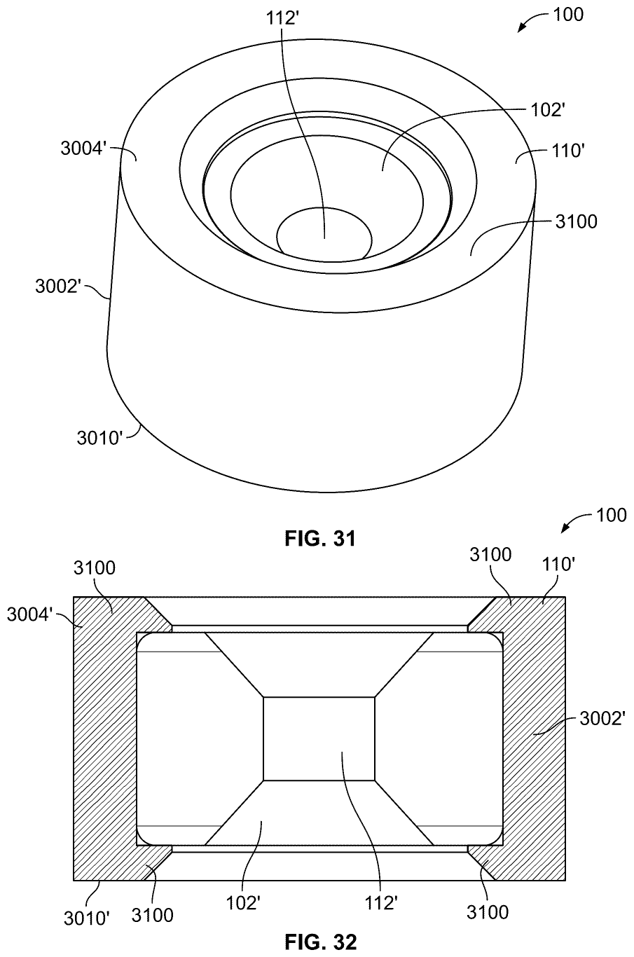

FIGS. 31 and 32 illustrate an alternate embodiment of the grommet 100 of FIG. 1-30. In the embodiment of FIGS. 31 and 32, like elements with the grommet 100 of FIG. 1-30 are denoted with the same reference numerals but followed by a primed suffix (′). FIGS. 31 and 32 illustrate embodiments of the grommet 100 including the support 110′ having lips 3100 that extends radially inward from the wall 3002′, around the core 102′, where the lips 3100 retain the core 102′ in the support 110′.

In this regard, the support 110′ includes the wall 3002′ that encloses an exterior surface of the core 102′ in both the lateral direction and the normal direction, and extends continuously along an entire length of the core 102′ in the longitudinal direction. The wall 3002′ is concentric with the aperture 112′ and forms a continuous sleeve surrounding the core 102′ in the radial direction.

The wall 3002′ includes the first wall end portion 3004′ and a second wall end portion 3010′ extended opposite the first wall end portion 3004′ in the longitudinal direction. The first wall end portion 3004′ and the second wall end portion 3010′ are positioned at longitudinally opposite ends of the core 102′, such that the wall 3002′ spans a full axial length of the grommet 100.

The support 110′ further includes the lips 3100 extended inward from the wall 3002′ and toward the core 102′ in the lateral direction and the normal direction. The lips 3100 project into contact with the core 102′ and abut opposite sides of the core 102′ in the longitudinal direction, holding the core 102′ in a longitudinal position within the wall 3002′. With this construction, the lips 3100 further retain the support 110′ on the core 102′, preventing disassembly of the grommet 100 during installation or use. In addition, the lips 3100 extend over and around the core 102′ to further shield the relatively soft core 102′ from external damage.

While in the depicted embodiment the support 110′ is molded together with the core 102′, in alternative embodiments the core 102′ and the support 110′ may be separately formed and subsequently assembled. In such an embodiment, variability in grommet assembly is increased with respect to a size and shape range of cables and closures that may be accommodated, as complementary sets of supports similar to the support 110′ and cores similar to the core 102′ may be mixed and matched to interface with each other by hand at the installation site.

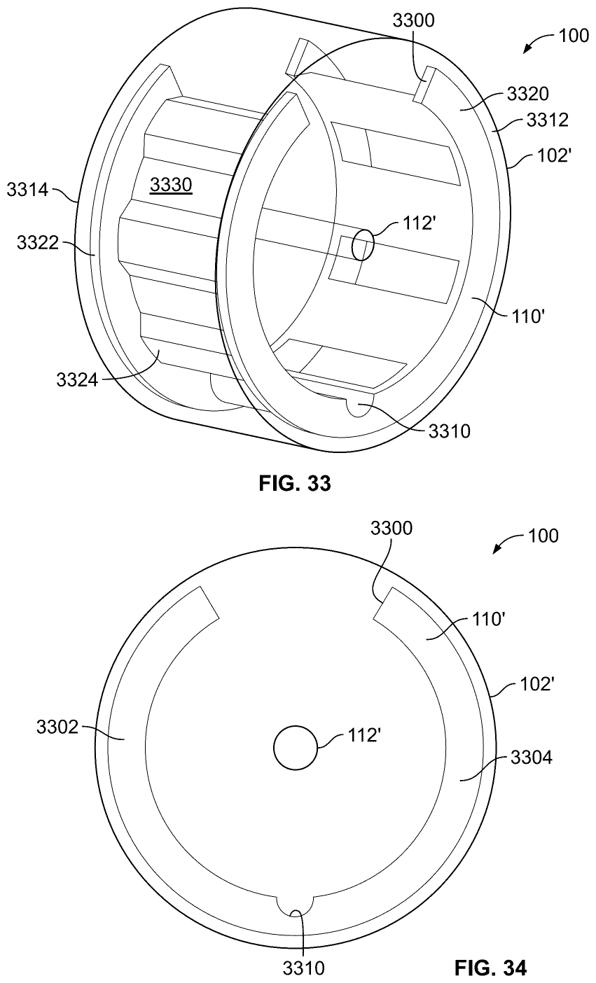

FIG. 33-35 illustrate an alternate embodiment of the grommet 100 of FIG. 1-32. In the embodiment of FIG. 33-35, like elements with the grommet 100 of FIG. 1-32 are denoted with the same reference numerals but followed by a primed suffix (′). FIG. 33-35 illustrate an embodiment of the grommet 100 where the support 110′ is embedded within the core 102′.

As shown in FIG. 33, the support 110′ is embedded within the core 102′ such that the core 102′ directly contacts the support 110′ and covers the support 110′ in the lateral direction and the normal direction. In the depicted embodiment, the support 110′ is completely enclosed in the core 102′, such that no portion of the support 110′ is exposed along an exterior surface of the grommet 100, and the material of the core 102′ surrounds the support 110′ continuously in the longitudinal direction, the lateral direction, and the normal direction. This full encapsulation of the support 110′ within the core 102′ provides enhanced protection of the support 110′ from environmental exposure and mechanical damage, and causes the support 110′ to reinforce the structural rigidity of the grommet 100 internally without altering an external profile of the core 102′.

As shown in FIG. 34, the support 110′ forms a cylindrical, C-shaped arc extended around the aperture 112′ in a circumferential direction of the core 102′, where the support 110′ defines an opening 3300 between a first leg 3302 and a second leg 3304 in the circumferential direction, at a first side. The support 110′ also includes a thinned portion 3310 connecting the first leg 3302 and the second leg 3304 at a second side opposite the first side in the radial direction, which may be along the lateral direction or the normal direction.

With this construction, the core 102′ is configured to flex at the thinned portion 3310 such that the first leg 3302 and the second leg 3304 move toward and away from each other across the opening 3300 when subjected to compressive or tensile forces. As such, the grommet 100 may employ a support 110′ manufactured from either metal or plastic material while still enabling controlled elastic deflection of the core 102′, maintaining compliance of the grommet 100 without overly restricting flexing of the core 102′ during installation or in-service loading.

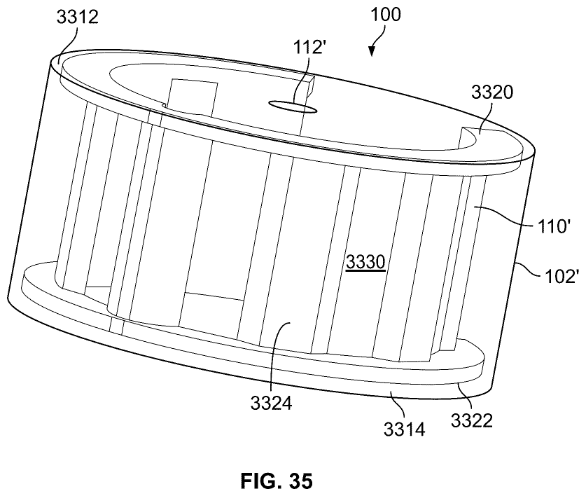

As shown in FIG. 35, the core 102′ includes a first core end 3312 and a second core end 3314 extended opposite the first core end 3312 in the longitudinal direction. The support 110′ includes a first support end 3320 and a second support end 3322 extended opposite the first support end 3320 in the longitudinal direction. The first support end 3320 is embedded in the core 102′ at a location closer to the first core end 3312 as compared to the second core end 3314 in the longitudinal direction, and the second support end 3322 is embedded in the core 102′ at a location closer to the second core end 3314 as compared to the first core end 3312 in the longitudinal direction.

The first support end 3320 is connected to the second support end 3322 through cross beams 3324 that extend across the core 102′ in the radial direction. The cross beams 3324 are evenly spaced in a circumferential direction of the core 102′ around the aperture 112′, defining voids 3330 in the support 110′ in the circumferential direction. The voids 3330 allow the material of the core 102′ to flow through and around the cross beams 3324 during molding, such that the softer durometer material of the core 102′ mechanically interlocks with the support 110′. In this manner, the support 110′ is securely retained within the core 102′, with the cross beams 3324 both reinforcing the structure of the support 110′ and anchoring the support 110′ against displacement relative to the core 102′. Such integration of the support 110′ and the core 102′ produces a composite grommet 100 that combines the elasticity of the core 102′ with the rigidity of the embedded chassis-like reinforcement.

While, as depicted, the cross beams 3324 form discrete edges in themselves and with the first support end 3320 and the second support end 3322, the boundaries between these features may alternatively be rounded or filleted. In such embodiments, the transition surfaces between the cross beams 3324, the first support end 3320, and the second support end 3322 are curved in a manner similar to that shown in FIG. 6, reducing stress concentrations at the intersections and facilitating improved material flow during molding of the core 102′. In this manner, the rounded features of boundaries at or along the cross beams 3324 may further enhance durability of the grommet 100 under repeated loading by limiting crack initiation at sharp junctions.

With continued reference to FIG. 35, the first support end 3320 and the second support end 3322 form overhanging lips that extend outward in the radial direction from the support 110′. The overhanging lips of the first support end 3320 and the second support end 3322 cooperate with the surrounding core 102′ to lock the support 110′ with the core 102′ in the longitudinal direction, and contain the softer material of the core 102′ inward in the longitudinal direction, concentrating compressive sealing forces at the aperture 112′ while maintaining structural stability of the grommet 100 when the cable 104 is inserted through the grommet 100.

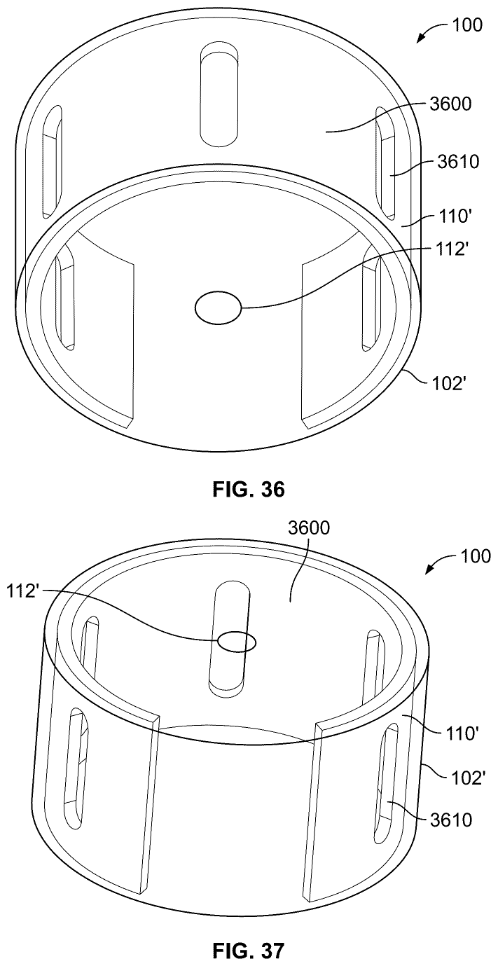

FIGS. 36 and 37 illustrate an alternate embodiment of the grommet 100 of FIG. 1-35. In the embodiment of FIGS. 36 and 37, like elements with the grommet 100 of FIG. 1-35 are denoted with the same reference numerals but followed by a primed suffix (′). FIGS. 36 and 37 illustrate an embodiment of the grommet 100 where the support 110′ is formed from a band 3600 embedded in the core 102′.

In this regard, the support 110′ is formed from a band 3600 disposed around the aperture 112′ in a circumferential direction of the core 102′. The band 3600 forms a cylindrical, C-shaped arc that is coaxial with the aperture 112′, extends continuously along the circumferential direction, and is spaced radially outward from the aperture 112′.

The band 3600 has a continuous thickness in the circumferential direction and defines slots 3610 that are evenly spaced from each other along the band 3600 in the circumferential direction. In certain embodiments, the support 110′ is manufactured from a sheet of metal that is press-cut to form the slots 3610 and then bent into the arc shape to create the band 3600. With this construction, the grommet 100 may be fabricated with enhanced manufacturability, as the band 3600 can be readily produced using conventional stamping and forming processes while still providing reinforcement and structural rigidity when embedded in the core 102′.

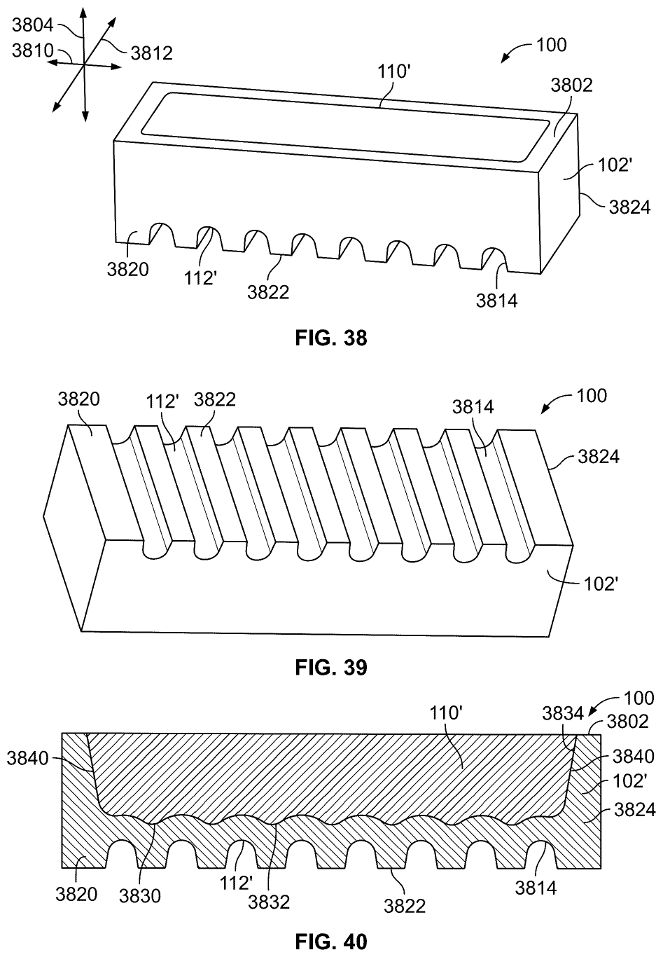

FIG. 38-40 illustrate an alternate embodiment of the grommet 100 of FIG. 1-37. In the embodiment of FIG. 38-40, like elements with the grommet 100 of FIG. 1-37 are denoted with the same reference numerals but followed by a primed suffix (′). FIG. 38-40 illustrate an embodiment of the grommet 100 including the support 110′ disposed in the core 102′.

As shown in FIG. 38, the support 110′ extends downward into the core 102′ from a top surface 3802 of the core 102′. More specifically, the support 110′ extends into the core 102′ in the normal direction, indicated by arrow 3804, orthogonal to the lateral direction, indicated by arrow 3810, and the longitudinal direction, indicated by arrow 3812. The support 110′ is flush with the top surface 3802 of the core 102′ in the lateral direction and the longitudinal direction. In this manner, the support 110′ is embedded in the core 102′, where the core 102′ surrounds the support 110′ in the lateral direction and the longitudinal direction, the support 110′ forms an exterior surface of the grommet 100, at the top surface 3802, facing in the normal direction, and the support 110′ is flush with the core 102′ at the exterior surface.

The support 110′ is formed from a material having a durometer higher than a durometer of material forming the core 102′, and may include silicone rubber of a higher Shore A hardness as compared to the core 102′, or a relatively rigid plastic or metal chassis. With this construction, the support 110′ reinforces the core 102′ and resists excessive deformation while lower-durometer portions of the core 102′ conform radially around the cables 920.

As shown in FIG. 38-40, the core 102′ defines a plurality of channels 3814 along a bottom surface 3820 of the core 102′, at a side of the core 102′ opposite the top surface 3802 in the normal direction. The channels 3814 extend in the longitudinal direction, and are defined and separated by walls 3822 in the lateral direction. Each of the walls 3822 are angled outward from a corresponding one of the channels 3814 in the normal direction, such that each of the channels 3814 narrow from the body of the core 102′, forming relief spaces in the channels 3814.

With this construction, the walls 3822 provide structural support between the channels 3814 while the relief spaces permit the walls 3822 to expand in the lateral direction, around the cables 920 when compressed in the normal direction. In this manner, the channels 3814 and the walls 3822 cooperate to increase flexibility of the bottom surface 3820, allowing the core 102′ to conform around the cables 920 with uniform sealing pressure. In the depicted embodiment, the channels 3814 are semi-cylindrical in cross-section, although other cross-sectional geometries, including rectangular, trapezoidal, or irregular profiles, such as those corresponding to figure-8 cable types, may be employed to tune deformation behavior in the walls 3822 and accommodate different cable shapes without departing from the scope of the present disclosure.

In the depicted embodiment, the core 102′ is illustrated as a top half 3824 of a two-piece construction, and in a similar manner shown in FIG. 22-24, is configured to mate with a corresponding and complementary bottom half including similar features and functioning in a similar manner as the top half 3824. In certain embodiments, the bottom half of the grommet 100 may have the same channel and wall geometry mirrored in the normal direction that forms a complementary structure with the top half. When the top half and the bottom half are pressed together in a closure, such as the example closure 900, the walls 3822 of the top half 3824 engage and oppose the corresponding walls 3822 of the bottom half in the normal direction.

In this manner, the core 102′ may be understood as including a first core portion and a second core portion that together define the aperture 112′ when pressed together in the normal direction, where the channels 3814 and the walls 3822 of each core portion align with one another to form continuous passageways extending in the longitudinal direction. The support 110′ is disposed on a side of the first core portion or the second core portion of the core 102′, opposite the aperture 112′ in the normal direction, reinforcing the assembled core while the opposing walls 3822 cooperate to seal around cables inserted through the aligned apertures.

With reference to FIG. 38, compression in the normal direction forces the walls 3822 of each core 102′ to expand toward each other in the lateral direction, filling the relief spaces, and closing the channels 3814 around corresponding cables. In this manner, the walls 3822 cooperate to define the apertures 112′ sealed around the corresponding cables in an associated closure. When the core 102′ forming the top half 3824 and the core 102′ forming the bottom half are compressed together in the closure 900, the relief spaces of the channels 3814 allow controlled lateral expansion of the walls 3822, ensuring that the apertures 112′ conform closely to outer surfaces of corresponding cables. With this construction, the grommet 100 achieves uniform sealing pressure around each of the corresponding cables, while maintaining sufficient flexibility to accommodate installation tolerances and cable geometries such as circular, oval, or figure-8 profiles, without departing from the scope of the present disclosure.

The support 110′ extends into the core 102′ from the top surface 3802 in the normal direction. With this construction, when the grommet 100 is compressed within the closure 900 in the normal direction, the support 110′ transfers a portion of the compressive force from the closure 900 into the surrounding material of the core 102′. In this manner, the support 110′ reinforces the core 102′ and distributes compressive loading uniformly across the walls 3822 without preventing the softer material of the core 102′ from deforming radially around corresponding cables.

As shown in FIG. 40, The support 110′ further includes ribs 3830 that extend downward into the core 102′ in the normal direction. The ribs 3830 are disposed between adjacent channels 3814 in the lateral direction, and project into corresponding walls 3822 of the core 102′. With this arrangement, the ribs 3830 stiffen the walls 3822, reducing uncontrolled collapse of the channels 3814 under load and ensuring that the deformation of the walls 3822 remains within an elastic range. In this manner, the ribs 2830 support the walls 3822 in the normal direction while permitting the walls 3822 to flex laterally into the relief spaces of the channels 3814.

Exterior edges 3832 along the ribs 3830 and inner surfaces 3834 of the support 110′ that contact the surrounding material of the core 102′ are rounded. With this construction, stress concentrations at the interface between the support 110′ and the core 102′ are reduced when the grommet 100 is compressed in the closure 900. Further, the exterior edges 3832 facilitate elastic bending of the walls 3822 by avoiding sharp corners that could otherwise cut into or tear the softer material of the core 102′ during repeated deformation cycles. In embodiments where both the core 102′ and the support 110′ are formed from rubber or plastic, the support 110′ and the core 102′ may be molded together in a common process such that outer surfaces of the support 110′ are bonded to the interfaced material of the core 102′ during curing. With this construction, the support 110′ is fixed in place within the core 102′, preventing separation or delamination under compression.

In the depicted embodiment, the support 110′ is enclosed by the surrounding material of the core 102′ in both the lateral direction and the longitudinal direction. With this construction, the support 110′ is embedded within the core 102′, where the core 102′ receives rigid external support in the lateral direction and the longitudinal direction from the surrounding structure of a corresponding closure. As the support 110′ reinforces the core 102′ internally, such a closure provides external constraint, maintaining dimensional stability in the grommet 100.

Exterior surfaces of the core 102′, such as exterior lateral surfaces 3840 are each angled inward along the normal direction from the top surface 3802 toward the bottom surface 3820 of the core 102′. With this construction, the support 110′ concentrates compressive forces applied in the normal direction by the closure 900 onto the walls 3822 of the core 102′. The angled orientation of the exterior lateral surfaces 3840 directs load paths toward the channels 3814, enhancing the ability of the walls 3822 to deform laterally into the relief spaces of the channels 3814. In this manner, the geometry of the exterior lateral surfaces 3840 increases sealing pressure around corresponding cables by promoting controlled lateral expansion of the walls 3822 under compression, while also reducing the risk of uncontrolled buckling or tearing of the softer material of the core 102′.

In the depicted embodiment, the support 110′ forms an exterior surface of the grommet 100 together with the top surface 3802′of the core 102′. With this construction, the support 110′ directly receives compressive forces from the closure 900 in the normal direction, thereby increasing the load-bearing capacity of the grommet 100 and limiting deformation of the softer material of the core 102′ under repeated compression cycles. In alternative embodiments, the support 110′ may protrude from, or be formed flush with an exterior side surface of the core 102′, such as exterior lateral surfaces 3840, reinforcing the core 102′ directly from that exterior side surface. In such embodiments, the support 110′ may act as a load-bearing reinforcement along one or more sides of the grommet 100, increasing rigidity in the lateral direction or the longitudinal direction, complementary to a determined geometry of an associated closure or corresponding cables.

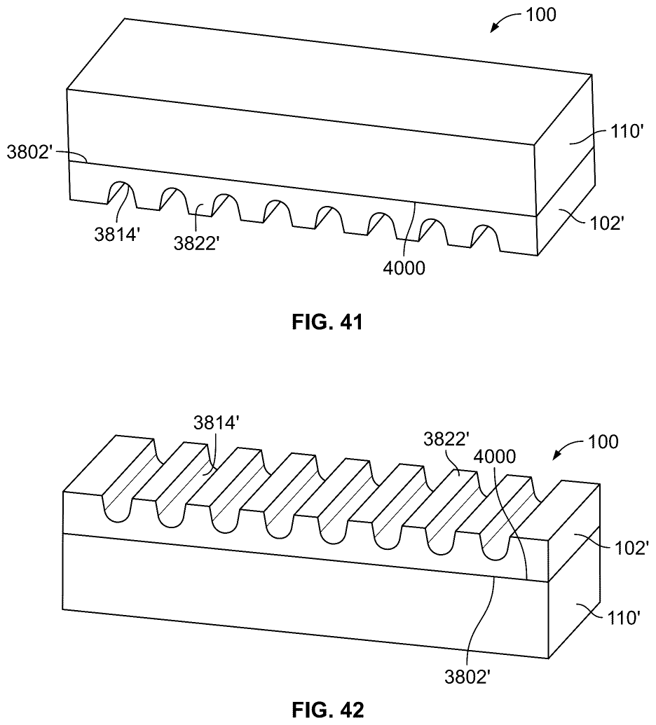

FIGS. 41 and 42 illustrate an alternate embodiment of the grommet 100 of FIG. 1-40. In the embodiment of FIGS. 41 and 42, like elements with the grommet 100 of FIG. 1-40 are denoted with the same reference numerals but followed by a primed suffix (′). FIGS. 41 and 42 illustrate an embodiment of the grommet 100 including the support 110′ the core 102′ and the support 110′ are fixed to each other along opposing planar rectangular surfaces, including the top surface 3802′ of the core 102′ and a bottom surface 4000 of the support 110′. With this construction, the support 110′ overlies the core 102′ and directly reinforces the walls 3822′ of the core 102′ from an associated closure in the normal direction.

The top surface 3802′ of the core 102′ and the bottom surface 4000 of the support 110′ are congruent and aligned with each other such that the core 102′ and the support 110′ form continuous, coextensive surfaces extended along the longitudinal direction and the lateral direction. With this construction, the overall rectangular outer profile of the grommet 100 matches the outer profile of an associated closure, such as the closure 900, interfacing with the grommet 100, facilitating uniform engagement and compression between the grommet 100 and the surrounding structure.

The support 110′ has a constant thickness in the normal direction, and evenly distributes compressive force from an associated closure in the normal direction across the entire top surface 3802′ of the core 102′. In this manner, compressive loads are transmitted uniformly to the walls 3822′ of the core 102′, ensuring that deformation occurs in a controlled and elastic manner while maintaining consistent sealing pressure around corresponding cables.

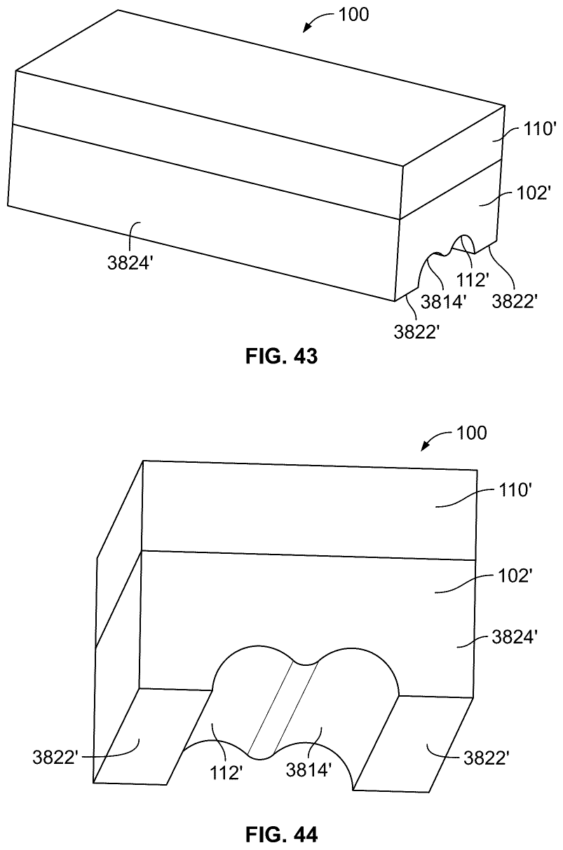

FIGS. 43 and 44 illustrate an alternate embodiment of the grommet 100 of FIG. 1-42. In the embodiment of FIGS. 43 and 44, like elements with the grommet 100 of FIG. 1-42 are denoted with the same reference numerals but followed by a primed suffix (′). FIGS. 43 and 44 illustrate an embodiment of the grommet 100 where the core 102′ defines the channel 3814′ with a double-arc surface open in the normal direction.

In this regard, the core 102′ defines the channel 3814′ by a recessed surface of the core 102′ that forms two adjacent arcuate segments arranged side-by-side and joined smoothly in the lateral direction, producing a double-arc profile in cross-section. The arcuate segments extend continuously in the longitudinal direction to form the channel 3814′, and have a complementary shape that seats and seals against a figure-8 style cable in the normal direction. The double-arc surface of the core 102′ is oriented such that the two arcuate segments are each open toward the same side in the normal direction, without overlapping one another along the normal axis. As such, the channel 3814′ is defined by distinct arcuate recesses disposed in parallel in the normal direction, providing two opposed cable-seating surfaces that extend alongside one another. With this construction, the channel 3814′ is adapted to receive and seal against a figure-8 cable when compressed in the normal direction, maintaining sealing engagement along both arcuate segments of the cable.

FIGS. 43 and 44 depict the top half 3824′ of the grommet 100. The grommet 100 includes a complementary bottom half (not shown) that mates with the top half 3824′ in the closure 900, in the normal direction. In embodiments, the bottom half is identical to the top half 3824′, and mirrors the top half 3824′ in the closure 900, in the normal direction. In this regard, the bottom half may include channels and walls shaped in a same or complementary manner that engages the channels 3814′ and the walls 3822′ of the top half 3824′ when pressed together in the normal direction. In this manner, the core 102′ includes the first core portion and the second core portion, each having a double-arc shaped surface that defines the aperture 112′ with an hourglass profile.

The complementary double-arc surfaces of the first core portion and the second core portion of the core 102′ seat against opposing arcuate segments of a figure-8 style cable, and distribute compressive sealing forces symmetrically across both lobes of the cable jacket. This construction produces a continuous hourglass profile in cross-section, increases sealing performance, and maintains positional stability of the figure-8 cable within the grommet 100.

While, as depicted, the core 102′ defines the aperture 112′ with the double-arc surface that seals against a figure-8 cable, the core 102′ may instead define other shaped surfaces that correspond to different cable geometries. For example, the core 102′ may define the aperture 112′ with a single arcuate contour for seating a round cable, a polygonal contour for seating a flat or multi-fiber ribbon cable, or a contoured recess tailored to specialized cable jackets where the channels 3814′ of the core 102′ is oriented to seat and seal against the corresponding cable profile in the normal direction without departing from the scope of the present disclosure.

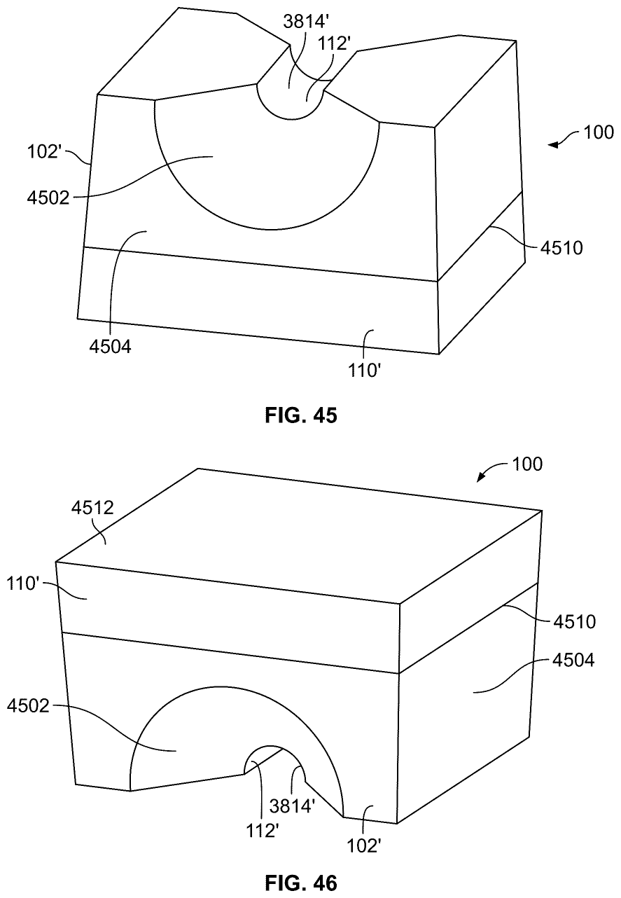

FIGS. 45 and 46 illustrate an alternate embodiment of the grommet 100 of FIG. 1-44. In the embodiment of FIGS. 45 and 46, like elements with the grommet 100 of FIG. 1-44 are denoted with the same reference numerals but followed by a primed suffix (′). FIGS. 45 and 46 illustrate an embodiment of the grommet 100 where the core 102′ and the support 110′ are formed as separate layers joined together along a planar interface.

As shown in FIG. 45, the core 102′ defines a recessed arcuate channel 3814′ shaped to receive a cable in the normal direction. The channel 3814′ extends continuously in the longitudinal direction of the core 102′ between opposing end faces, and includes a concave semi-cylindrical portion 4502 arranged coaxially with the aperture 112′. The semi-cylindrical portion 4502 is conical and transitions into planar wall surfaces 4504 that angle inward toward the aperture 112′. With this construction, the channel 3814′ forms a seating surface extended along the longitudinal direction, that may distribute sealing forces around a cable. The angled orientation of the wall surfaces 4504 permits the core 102′ to expand in both the longitudinal direction and the lateral direction when compressed in the normal direction between the support 110′ and the aperture 112′, enhancing elastic compliance while maintaining sealing contact with a cable at the aperture 112′.

With continued reference to FIG. 45, the support 110′ forms a separate layer positioned beneath the core 102′ along the normal direction. The support 110′ extends in both the longitudinal direction and the lateral direction to form a rectangular base that stabilizes the overlying core 102′. The planar interface 4510 between the core 102′ and the support 110′ provides structural reinforcement in the normal direction, resisting deformation of the core 102′ when compressed in a closure.

As shown in FIG. 46, the channel 3814′ extends in the longitudinal direction through an entire length of the core 102′ such that the arcuate portion 4502 and the wall surfaces 4504 form a continuous passage through the grommet 100. The support 110′ maintains a uniform thickness beneath the core 102′ and includes a flat exterior surface 4512 that engages the closure in the normal direction. With this construction, the support 110′ distributes compressive forces evenly across the core 102′ while the channel 3814′ provides reliable cable seating and sealing performance along the longitudinal direction.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A grommet comprising:
a core that defines an aperture in a longitudinal direction, wherein the aperture is a straight through hole and the core is formed from a material having a first durometer; and
a support fixed with the core, wherein the support is spaced from the aperture in a lateral direction or a normal direction orthogonal the longitudinal direction, and is formed from a material having a second durometer that is higher than the first durometer.

2. The grommet of claim 1, wherein the core and the support are cylindrical, concentric with the aperture, and rounded about the longitudinal direction, and
the support is disposed on an exterior surface of the core or within the core, around opposite sides of the aperture in the lateral direction or the normal direction.

3. The grommet of claim 2, wherein the support is disposed on the exterior surface of the core and includes ribs that extend outward, away from the core in the lateral direction and the normal direction.

4. The grommet of claim 2, wherein the support includes a wall that encloses the exterior surface of the core in the lateral direction and the normal direction,
the wall includes a first wall end portion and a second wall end portion extended opposite the first wall end portion in the longitudinal direction, and
the support includes a fin that extends inward from the wall, into the core and toward the aperture in the lateral direction and the normal direction, the fin extending from a position on the wall closer to a middle point of the wall in the longitudinal direction as compared to the first wall end portion and the second wall end portion.

5. The grommet of claim 2, wherein the support includes a wall that encloses an exterior surface of the core in the lateral direction and the normal direction, and extends continuously along an entire length of the core in the longitudinal direction,
the wall includes a first wall end portion and a second wall end portion extended opposite the first wall end portion in the longitudinal direction, and
the support includes lips extended from the wall and toward the core in the lateral direction or the normal direction, and the lips abut opposite sides of the core in the longitudinal direction.

6. The grommet of claim 1, wherein the support is embedded within the core such that the core directly contacts the support and covers the support in the lateral direction and the normal direction.

7. The grommet of claim 6, wherein the core includes a first core end and a second core end extended opposite the first core end in the longitudinal direction, the support includes a first support end and a second support end extended opposite the first support end in the longitudinal direction, the first support end is embedded in the core at a location closer to the first core end as compared to the second core end in the longitudinal direction, and the second support end is embedded in the core at a location closer to the second core end as compared to the first core end in the longitudinal direction.

8. The grommet of claim 7, wherein the first support end is connected to the second support end through cross beams, and the cross beams are evenly spaced in a circumferential direction of the core around the aperture.

9. The grommet of claim 1, wherein the support forms a C-shaped arc extended around the aperture in a circumferential direction of the core, where the support defines an opening at a first side, and thinned portion at a second side opposite the first side in the lateral direction or the normal direction.

10. The grommet of claim 1, wherein the support is formed from a band disposed around the aperture in a circumferential direction of the core, has a continuous thickness in the circumferential direction, and defines slots that are evenly spaced from each other along the band in the circumferential direction.

11. The grommet of claim 1, wherein the support is a unitary body formed from a plastic or a metal, and the core is a unitary body formed from a rubber or an elastomer.

12. The grommet of claim 1, wherein the core and the support are fixed to each other along opposing planar rectangular surfaces, the core includes a first core portion and a second core portion that define the aperture when pressed together in the normal direction, and the support is disposed on a side of the first core portion or the second core portion opposite the aperture in the normal direction.

13. The grommet of claim 12, wherein the first core portion and the second core portion each include a double-arc shaped surface that defines the aperture with an hourglass profile.

14. The grommet of claim 13, wherein the rectangular surfaces of the core and the support are congruent and aligned with each other such that the core and the support form continuous surfaces extended along the longitudinal direction and the lateral direction.

15. The grommet of claim 1, wherein the support is embedded in the core, where the core surrounds the support in the lateral direction and the longitudinal direction, the support forms an exterior surface of the grommet facing in the normal direction, and the support is flush with the core at the exterior surface.

16. The grommet of claim 1, wherein the core and the support are molded together, the core being formed from a first elastomer having the first durometer, and the support being formed from a second elastomer having the second durometer.

17. A grommet comprising:
a core that defines an aperture in a longitudinal direction, wherein the aperture is a straight through hole extended through a first end surface of the core and a second end surface of the core opposite the first end surface in the longitudinal direction; and
a support fixed with the core, wherein the support surrounds the core and extends from the core in a lateral direction orthogonal to the longitudinal direction, the support is spaced from the aperture across the core in the lateral direction, and the first end surface or the second end surface are inclined outward in the longitudinal direction from the aperture toward the support.

18. The grommet of claim 17, wherein the core and the support are cylindrical and concentric with the aperture,
both the first end surface of the core and the second end surface of the core are inclined outward in the longitudinal direction, at the aperture, and form a frusto-conical shape extended outward from the support in the longitudinal direction,
the support forms a first ledge that extends straight from the frusto-conical shape at the first end surface of the core in the lateral direction and the longitudinal direction, and
the support forms a second ledge that extends straight from the frusto-conical shape at the second end surface in the lateral direction and the longitudinal direction.

19. The grommet of claim 18, wherein the support has a constant thickness around an entire circumference of the core, in a radial direction orthogonal to the longitudinal direction,
the support extends continuously along the core in the longitudinal direction, and terminates at the first end surface of the core and the second end surface of the core,
the core and the support are integrally formed from a same material including a rubber or an elastomer.

20. A grommet comprising:
a core that defines an aperture in a longitudinal direction, wherein the aperture is a straight through hole extended through a first core end surface and a second core end surface opposite the first core end surface in the longitudinal direction; and
a support integrally formed with the core, wherein the support is cylindrical and concentric with the core and extended around the core in a circumferential direction orthogonal to the longitudinal direction,
wherein the first core end surface and the second core end surface are inclined inward in the longitudinal direction from the aperture toward the support in a radial direction orthogonal to the longitudinal direction.
